(19) United States
(12) Patent Application Publication
(10) Pub. No.: US 2022/0300899 A1
(43) Pub. Date: Sep. 22, 2022

(54) INFORMATION PROCESSING APPARATUS, INFORMATION PROCESSING SYSTEM, AND INFORMATION PROCESSING METHOD

(71) Applicant: Ryo TANEDA, Kanagawa (JP)

(72) Inventor: Ryo TANEDA, Kanagawa (JP)

(21) Appl. No.: 17/564,263

(22) Filed: Dec. 29, 2021

(30) Foreign Application Priority Data
Mar. 19, 2021 (JP) 2021-046486

(51) Int. Cl. G06Q 10/08; G06F 3/0482; G06F 3/04886

(52) U.S. Cl. CPC G06Q 10/0875; G06F 3/0482; G06F 3/04886

(57) ABSTRACT

An information processing apparatus includes circuitry that registers information of a first type of form based on first input information from a first terminal apparatus, and causes a second terminal apparatus different from the first terminal apparatus to display an input screen based on the information of the first type of form. The input screen receives input of information of a second type of form corresponding to the first type of form. The circuitry registers the information of the second type of form based on second input information input on the input screen. When the second input information includes an unmatched information item that fails to match a corresponding information item in the information of the first type of form corresponding to the second type of form, the circuitry causes the second terminal apparatus to display a registration screen for inputting notification information related to the unmatched information item.

### CROSS-REFERENCE TO RELATED APPLICATION

This patent application is based on and claims priority pursuant to 35 U.S.C. § 119(a) to Japanese Patent Application No. 2021-046486, filed on Mar. 19, 2021, in the Japan Patent Office, the entire disclosure of which is hereby incorporated by reference herein.

### BACKGROUND

### Technical Field

The present invention relates to an information processing apparatus, an information processing system, and an information processing method.

### Description of the Related Art

In a typical transaction between a provider (hereinafter referred to as the supplier) of a commercial product or service and a user (hereinafter referred to as the buyer) of the provided commercial product or service, matching of the transaction is executed with forms such as order sheet and invoice, for example.

When the supplier issues the invoice to the buyer, for example, the billing amount may be changed from the order price described in the order sheet because of a reason such as price rise, price drop, discount, or stockout. In this case, the price described in the invoice does not match the price described in the order sheet, preventing the buyer from reconciling the order sheet with the invoice.

### SUMMARY

In one embodiment of this invention, there is provided an information processing apparatus that includes, for example, circuitry that registers information of a first type of form based on first input information from a first terminal apparatus, and causes a second terminal apparatus different from the first terminal apparatus to display an input screen based on the information of the first type of form. The input screen receives input of information of a second type of form corresponding to the first type of form. The circuitry further registers the information of the second type of form based on second input information input on the input screen. When the second input information includes an unmatched information item that fails to match a corresponding information item in the information of the first type of form corresponding to the second type of form, the circuitry further causes the second terminal apparatus to display a registration screen for inputting notification information related to the unmatched information item.

In one embodiment of this invention, there is provided an information processing system that includes, for example, an information processing apparatus, which is communicable with a first terminal apparatus and a second terminal apparatus different from the first terminal apparatus, and the second terminal apparatus. The information processing apparatus includes first circuitry that registers information of a first type of form based on first input information from the first terminal apparatus. Based on the information of the first type of form, the first circuitry transmits, to the second terminal apparatus, information of an input screen for receiving input of information of a second type of form corresponding to the first type of form. The first circuitry further registers the information of the second type of form based on second input information input on the input screen. The second terminal apparatus includes a display and second circuitry. The display displays the input screen based on the information of the input screen. When the second input information includes an unmatched information item that fails to match a corresponding information item in the information of the first type of form corresponding to the second type of form, the second circuitry controls the display to display a registration screen for inputting notification information related to the unmatched information item.

In one embodiment of this invention, there is provided an information processing method that includes, for example, registering information of a first type of form based on first input information from a first terminal apparatus, causing a second terminal apparatus different from the first terminal apparatus to display an input screen for receiving input of information of a second type of form corresponding to the first type of form based on the information of the first type of form, and registering the information of the second type of form based on second input information input on the input screen. When the second input information includes an unmatched information item that fails to match a corresponding information item in the information of the first type of form corresponding to the second type of form, the method further includes causing the second terminal apparatus to display a registration screen for inputting notification information related to the unmatched information item.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of the system configuration of an information processing system according to an embodiment of the present invention;

FIG. 2 is a diagram illustrating an overview of a procedure of a transaction of the embodiment;

FIG. 3 is a diagram illustrating an example of the hardware configuration of a computer included in the information processing system of the embodiment;

FIG. 4 is a diagram illustrating an example of the functional configuration of the information processing system of the embodiment;

FIG. 5 is a diagram illustrating an example of transaction management information of the embodiment;

FIG. 6 is a diagram illustrating an example of tenant management information of the embodiment;

FIG. 7 is a sequence diagram illustrating an example of an ordering process of the embodiment;

FIG. 8 is a diagram illustrating an example of an order sheet creation screen of the embodiment;

FIG. 9 is a diagram illustrating an example of an order sheet transmission screen of the embodiment;

FIG. 10 is a diagram illustrating an example of an issued order sheet database of the embodiment;

FIG. 11 is a diagram illustrating an example of an order sheet receipt screen of the embodiment;

FIG. 12 is a diagram illustrating an example of a received order sheet database of the embodiment;

FIG. 13 is a sequence diagram illustrating an example of an invoicing process of the embodiment;

FIG. 14 is a diagram illustrating an example of a received order sheet list screen of the embodiment;

FIGS. 15 and 16 are diagrams illustrating an example of an invoice creation screen of the embodiment;

FIG. 17 is a flowchart illustrating an example of an invoice editing process of the embodiment;

FIG. 18 is a diagram illustrating an example of a notification information registration screen of the embodiment;

FIG. 19 is a flowchart illustrating another example of the invoice editing process of the embodiment;

FIG. 20 is a diagram illustrating another example of the notification information registration screen of the embodiment;

FIG. 21 is a diagram illustrating an example of an invoice of the embodiment;

FIG. 22 is a diagram illustrating an example of an invoice transmission screen of the embodiment;

FIG. 23 is a diagram illustrating an example of an issued invoice database of the embodiment;

FIG. 24A is a diagram illustrating an example of issued notification information of the embodiment;

FIG. 24B is a diagram illustrating an example of received notification information of the embodiment;

FIG. 25 is a diagram illustrating an example of a received invoice database of the embodiment;

FIG. 26 is a flowchart illustrating an example of a matching process of the embodiment;

FIG. 27 is a sequence diagram illustrating an example of a checking process of the embodiment;

FIG. 28 is a diagram illustrating an example of an invoice list screen of the embodiment;

FIG. 29 is a diagram illustrating an example of a check screen of the embodiment;

FIG. 30 is a diagram illustrating an example of notification information of the embodiment;

FIG. 31 is a diagram illustrating another example of the check screen and the notification information of the embodiment; and

FIG. 32 is a diagram illustrating an example of output information of the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An embodiment of the present invention will be described in detail below with reference to the drawings.

A system configuration of an information processing system of the embodiment will be described.

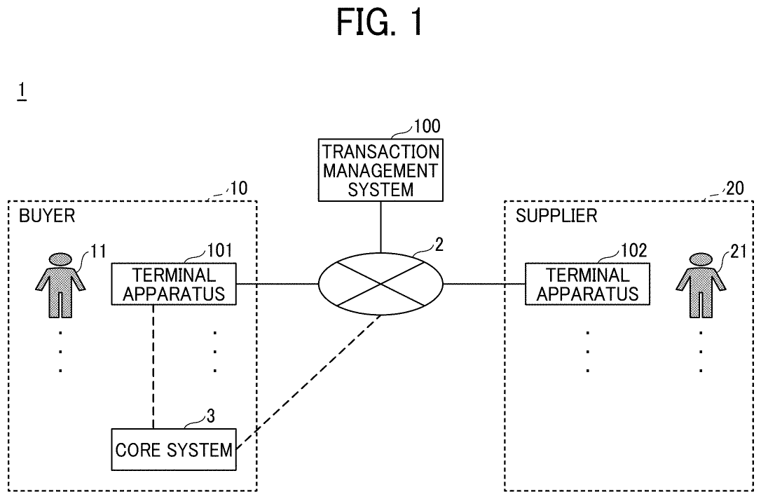

FIG. 1 is a diagram illustrating an example of the system configuration of the information processing system of the embodiment. An information processing system 1 of the embodiment is a system that manages transactions conducted between a provider of a commercial product or service (hereinafter referred to as the supplier 20) and a user of the provided commercial product or service (hereinafter referred to as the buyer 10) with forms such as order sheet and invoice, for example. The information processing system 1 includes a transaction management system 100, a terminal apparatus 101, and a terminal apparatus 102, which are communicably connected to each other via a communication network 2 such as the Internet or a local area network (LAN), for example.

The transaction management system 100 (an example of an information processing apparatus) is a system including one or more information processing apparatuses each configured as a computer. The transaction management system 100 functions as a web (world wide web) server that provides input screens (e.g., web pages) for inputting the information of the forms such as the order sheet (or purchase order) and the invoice, for example, to manage the transactions between the supplier 20 and the buyer 10. The transaction management system 100 further functions to store the information of the forms input on the input screens in a storage device, for example, and manage the stored information.

The terminal apparatus 101 (an example of a first terminal apparatus) is used by a buyer user 11 of the buyer 10 (an example of a first user). The terminal apparatus 101 is an information terminal with the function of a web browser, such as a personal computer (PC), a tablet terminal, or a smartphone, for example. The buyer user 11 of the buyer 10 is not limited to a single user, and may include a plurality of users each having a certain role in an organization acting as the buyer 10. Further, the terminal apparatus 101 may be any terminal used by the buyer user 11 of the buyer 10. For example, the terminal apparatus 101 may be a personal terminal, or may be a shared terminal used by a plurality of buyer users 11 of the buyer 10. Therefore, the terminal apparatus 101 used by the buyer user 11 of the buyer 10 (i.e., the first user) is not limited to a single terminal; different terminals may be used as the terminal apparatus 101 to access the transaction management system 100.

The terminal apparatus 101 used by the buyer user 11 of the buyer 10 is also used to exchange information with a core system 3, such as an accounting system, a payment system, or an order system, for example, directly or via the transaction management system 100.

The terminal apparatus 102 (an example of a second terminal apparatus) is used by a supplier user 21 of the supplier 20 (an example of a second user). The terminal apparatus 102 is an information terminal with the function of a web browser, such as a PC, a tablet terminal, or a smartphone, for example. Similarly to the buyer user 11 of the buyer 10, the supplier user 21 of the supplier 20 is not limited to a single user, and may include a plurality of users each having a certain role in an organization acting as the supplier 20. Further, the terminal apparatus 102 may be any terminal used by the supplier user 21 of the supplier 20. For example, the terminal apparatus 102 may be a personal terminal, or may be a shared terminal used by a plurality of supplier users 21 of the supplier 20. Therefore, the terminal apparatus 102 used by the supplier user 21 of the supplier 20 (i.e., the second user) is not limited to a single terminal; different terminals may be used as the terminal apparatus 102 to access the transaction management system 100.

The core system 3 is a business system used by the organization acting as the buyer 10, such as an accounting system, a payment system, or an order system, for example. It is assumed in the embodiment that the core system 3 is an external system outside the information processing system 1. The core system 3, however, is not limited to this example. For instance, at least part of functions of the core system 3 may be included in the information processing system 1.

An overview of a procedure of a transaction of the embodiment will be described.

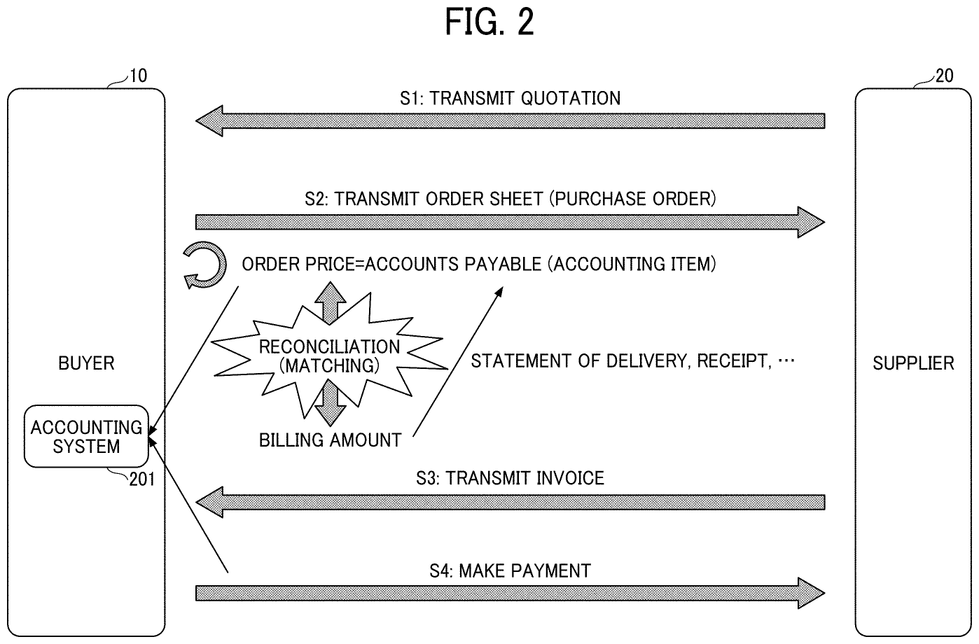

FIG. 2 is a diagram illustrating an overview of a procedure of a transaction of the embodiment. It is assumed here that forms such as quotation, order sheet (or purchase order), and invoice are transmitted and received as electronic data.

In response to receipt of a request for quotation from the buyer 10, for example, the supplier 20 transmits a quotation to the buyer 10 (step S1). The quotation includes information items such as the article, the unit price, the quantity, and the total amount of a requested commercial product or service.

Based on the quotation, the buyer 10 determines information items such as the article, the unit price, and the quantity of the commercial product or service to order, and transmits an order sheet (or purchase order) including the information items to the supplier 20 (step S2). The order price, i.e., the total amount described in the order sheet, is registered in an accounting system 201, which is a part of the core system 3, under an accounting item “accounts payable,” for example.

Then, the supplier 20 supplies the commercial product or service ordered with the order sheet to the buyer 10, and transmits an invoice to the buyer 10 (step S3). The invoice includes information items such as the article, the unit price, the quantity, and the total amount of the supplied commercial product or service, for example.

In response to receipt of the invoice, the buyer 10 executes reconciliation (i.e., matching) between the information of the order sheet (e.g., the order price) and the information of the invoice (e.g., the billing amount). Then, if there is no error in the information of the order sheet or the information of the invoice, the buyer 10 makes a payment to the supplier 20 (step S4).

Herein, the term “reconciliation” refers to comparing the information of the order sheet (e.g., the article, the unit price, the quantity, and the total amount) with the information of the invoice (e.g., the article, the unit price, the quantity, and the total amount), for example, and checking if there is no error in the information. The term “reconciliation” is basically used synonymously with the term “matching,” but may imply in some cases locating the error in case of unmatching between the information of the order sheet and the information of the invoice, for example, and making the information of the order sheet and the information of the invoice consistent with each other. In the following description, therefore, the term “matching” will be used instead.

If there is a difference between the information of the order sheet and the information of the invoice, the buyer 10 is unable to proceed with the payment. In this case, according to a typical information processing system, the buyer 10 and the supplier 20 check with each other to locate the cause of the difference between the information of the order sheet and the information; the discrepancy is manually resolved to determine the payment.

According to this information processing system, therefore, if the price in the invoice has been changed by the supplier 20 for some reason, the buyer 10 normally contacts and checks with the supplier 20 about the reason for the change in the price before proceeding with the payment procedure. In the information processing system that executes the matching between the form issued by the buyer 10 and the form issued by the supplier 20, the change in the billing amount by the supplier 20 thus increases the workload on the buyer 10.

In view of the above, the transaction management system 100 of the embodiment determines whether the information (e.g., the price) described in the invoice created by the supplier 20 has been changed from the information described in the order sheet. If the information of the invoice has been changed from the information of the order sheet, the transaction management system 100 prompts the supplier 20 to register notification information related to the change. Further, when the buyer 10 receives the invoice, the transaction management system 100 enables the terminal apparatus 101 of the buyer 10 to display the notification information related to the change, which has been input by the supplier 20. When the price in the invoice is changed by the supplier 20, therefore, the buyer 10 is able to readily determine the validity of the billing amount without contacting the supplier 20.

According to the information processing system 1 of the embodiment, which executes the matching between the form issued by the buyer 10 and the form issued by the supplier 20, the workload on the buyer 10 in the case of a change in the billing amount is reduced.

A hardware configuration of the information processing system 1 of the embodiment will be described.

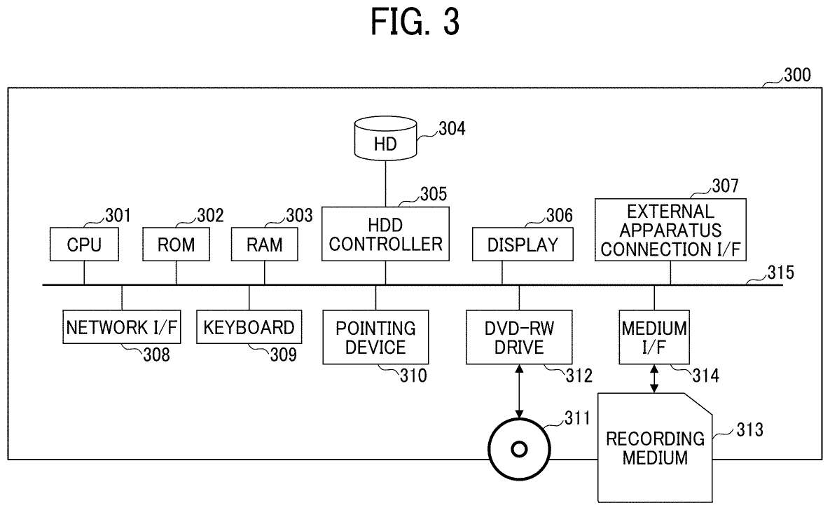

Each of the terminal apparatus 101, the terminal apparatus 102, and the transaction management system 100 has the hardware configuration of a typical computer 300 as illustrated in FIG. 3, for example. Alternatively, the transaction management system 100 may be implemented by a plurality of computers 300.

FIG. 3 is a diagram illustrating an example of the hardware configuration of the computer 300 of the embodiment. As illustrated in FIG. 3, for example, the computer 300 includes a central processing unit (CPU) 301, a read only memory (ROM) 302, a random access memory (RAM) 303, a hard disk (HD) 304, a hard disk drive (HDD) controller 305, a display 306, an external apparatus connection interface (I/F) 307, a network I/F 308, a keyboard 309, a pointing device 310, a digital versatile disk-rewritable (DVD-RW) drive 312, a medium I/F 314, and a bus line 315.

The CPU 301 controls the overall operation of the computer 300. The ROM 302 stores a program used to drive the CPU 301, such as an initial program loader (IPL), for example. The RAM 303 is used as a work area for the CPU 301. The HD 304 stores various data of programs, for example. The HDD controller 305 controls writing and reading of various data to and from the HD 304 under the control of the CPU 301.

The display 306 displays various information such as a cursor, menus, windows, text, and images. The external apparatus connection I/F 307 is an interface for connecting the computer 300 to various external apparatuses. The external apparatuses in this case include a universal serial bus (USB) memory and a printer, for example. The network I/F 308 is an interface for performing data communication via the communication network 2.

The keyboard 309 is an input device including a plurality of keys for inputting text, numerical values, and various instructions, for example. The pointing device 310 is an input device used to select and execute various instructions, select a processing target, and move the cursor, for example. The DVD-RW drive 312 controls writing and reading of various data to and from a DVD-RW 311 as an example of a removable recording medium. The DVD-RW 311 may be replaced by another type of removable recording medium. The medium I/F 314 controls writing (i.e., storage) and reading of data to and from a recording medium 313 such as a flash memory. The bus line 315 includes an address bus, a data bus, and various control signal lines for electrically connecting the above-described components to each other.

A functional configuration of the information processing system 1 of the embodiment will be described.

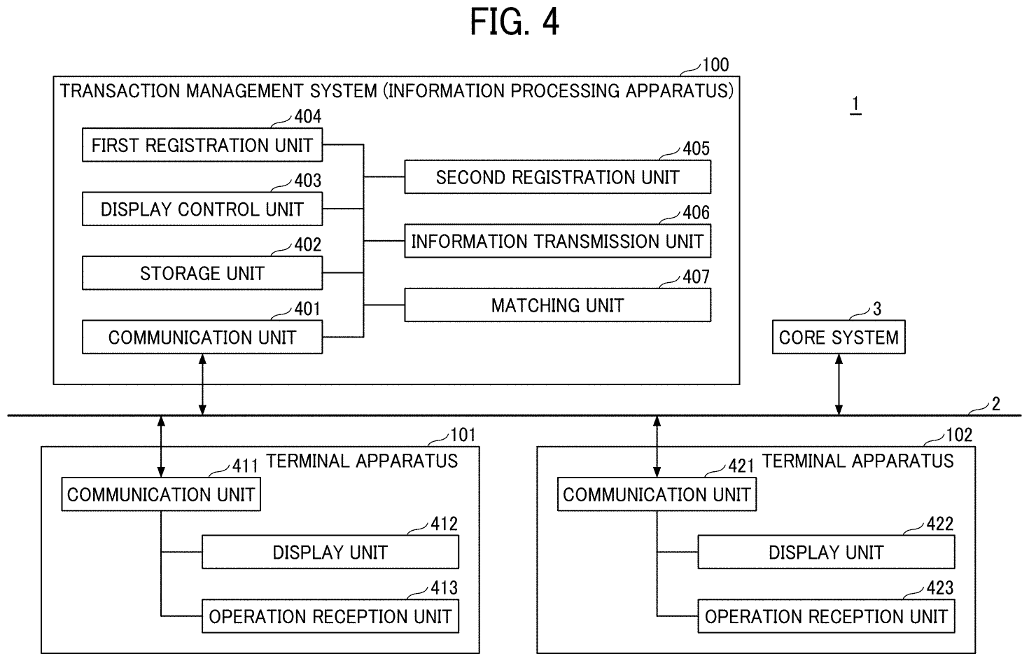

FIG. 4 is a diagram illustrating an example of the functional configuration of the information processing system 1 of the embodiment.

A functional configuration of the transaction management system 100 will first be described.

The transaction management system 100 (an information processing apparatus) executes a particular program with one or more computers 300 as illustrated in FIG. 3, for example, to implement the functional configuration as illustrated in FIG. 4. In the example of FIG. 4, the transaction management system 100 includes a communication unit 401, a storage unit 402, a display control unit 403, a first registration unit 404, a second registration unit 405, an information transmission unit 406, and a matching unit 407, for example. At least part of these functional units may be implemented by hardware.

The communication unit 401 execute a communication process of connecting the transaction management system 100 to the communication network 2 with the network IF 308, for example, and communicating with the terminal apparatus 101, the terminal apparatus 102, or the core system 3, for example.

The storage unit 402 executes a storage process of storing various information, such as transaction management information and tenant management information, in a storage device such as the HD 304, for example.

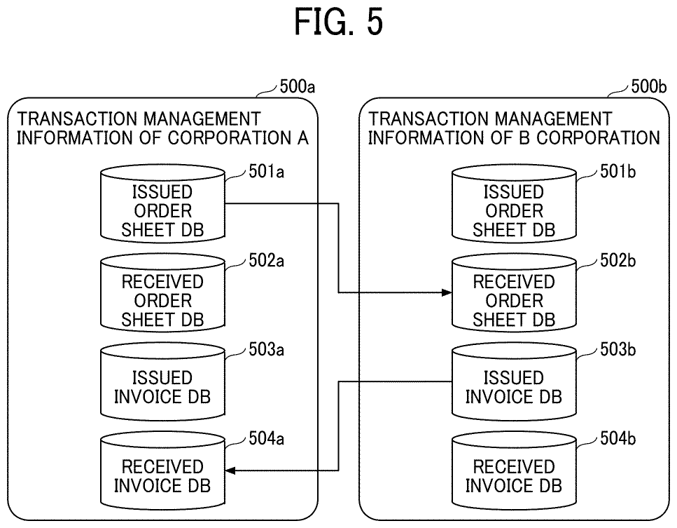

FIG. 5 is a diagram illustrating an example of the transaction management information of the embodiment. The storage unit 402 stores transaction management information 500 for each tenant. The tenant is a subscriber of a service provided by the information processing system 1, such as a company, for example. The transaction management information 500 includes databases such as an issued order sheet database (DB) 501, a received order sheet DB 502, an issued invoice DB 503, and a received invoice DB 504.

In the example of FIG. 5, transaction management information 500a of Corporation A as an example of the buyer 10 includes databases such as an issued order sheet DB 501a, a received order sheet DB 502a, an issued invoice DB 503a, and a received invoice DB 504a. Further, transaction management information 500b of B Corporation as an example of the supplier 20 includes databases such as an issued order sheet DB 501b, a received order sheet DB 502b, an issued invoice DB 503b, and a received invoice DB 504b.

For example, in the transaction management system 100, a user of Corporation A registers, in the issued order sheet DB 501a, the information of an order sheet issued to B Corporation. Further, when a user of B Corporation performs an operation of receiving the order sheet, the transaction management system 100 copies the information of the order sheet to the received order sheet DB 502b from the issued order sheet DB 501a. Similarly, the transaction management system 100 registers, in the issued invoice DB 503b, the information of an invoice issued to Corporation A by the user of B Corporation. Further, when the user of Corporation A performs an operation of receiving the invoice, the transaction management system 100 copies the information of the invoice to the received invoice DB 504a from the issued invoice DB 503b. Each of Corporation A and B Corporation may act as the buyer 10 or the supplier 20.

The configuration of the transaction management information 500 illustrated in FIG. 5 (i.e., the transaction management information 500a and 500b) is illustrative. For example, the transaction management system 100 may store the transaction management information 500 of a plurality of tenants as common transaction management information, and may identify the transaction management information 500 of each of the tenants with identification information for identifying the tenant.

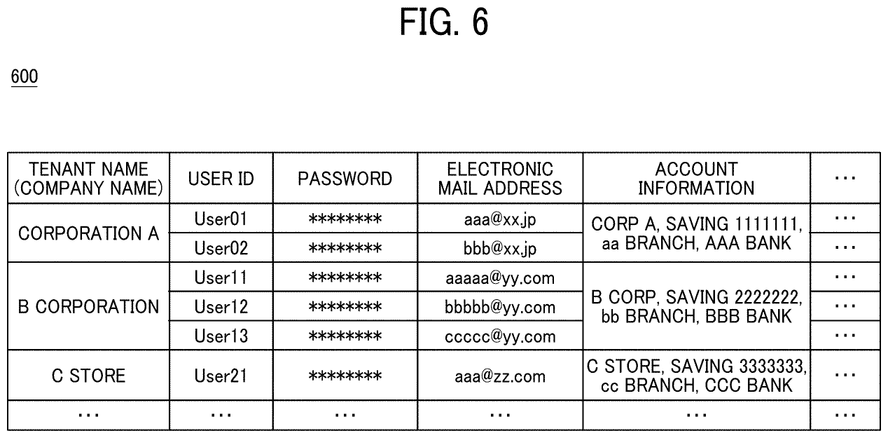

FIG. 6 illustrates an example of the tenant management information of the embodiment. The storage unit 402 stores the information of each of the tenants in tenant management information 600 as illustrated in FIG. 6, for example. In the example of FIG. 6, the tenant management information 600 includes information items such as “tenant name (company name),” “user identifier (ID).” “password,” “electronic mail address,” and “account information.” The item “tenant name (company name)” is information representing the name of the tenant, such as a company name, for example. The tenant name may be a tenant ID for identifying the tenant, for example. The item “user ID” is identification information for identifying a user registered in association with the tenant. The item “password” is an example of authentication information for authenticating the user corresponding to the user ID. The item “electronic mail address” is an electronic mail address of the user corresponding to the user ID. The item “account information” is the information of a payee account of the tenant. The tenant management information 600 is previously registered in the transaction management system 100 by an administrator who administers the transaction management system 100, for example.

Referring back to FIG. 4, the description of the functional configuration of the transaction management system 100 will be continued.

The display control unit 403 executes a display control process of causing the terminal apparatus 101 used by the buyer user 11 of the buyer 10 and the terminal apparatus 102 used by the supplier user 21 of the supplier 20 to display screens for inputting various information of transactions. For example, the display control unit 403 causes the terminal apparatus 101 used by the buyer user 11 (an example of the first user) of the buyer 10 to display various display screens such as an order sheet creation screen, an order sheet transmission screen, an invoice list screen, an invoice check screen, and a notification information display screen.

The display control unit 403 further causes the terminal apparatus 102 used by the supplier user 21 (an example of the second user) of the supplier 20 to display various display screens such as an order sheet receipt screen, a received order sheet list screen, an invoice creation screen, an invoice transmission screen, and a notification information registration screen.

For example, based on the information of an order sheet registered in the received order sheet DB 502, the display control unit 403 generates the invoice creation screen corresponding to the order sheet, and causes the terminal apparatus 102 to display the generated invoice creation screen. Further, if input information input on the invoice creation screen includes an information item not matching the corresponding information item in the information of the order sheet corresponding to the invoice, the display control unit 403 causes the terminal apparatus 102 to display the notification information registration screen for inputting the notification information related to the unmatched information item (e.g., the reason for the unmatching).

As a specific example, the display control unit 403 functions as a web server that causes the web browsers of the terminal apparatuses 101 and 102 to display web pages for receiving input of various information of transactions.

The first registration unit 404 executes a first registration process of registering the information of a first type of form (e.g., the order sheet) based on input information input on an input screen displayed by the terminal apparatus 101 under the control of the display control unit 403 to receive input of the information of the first type of form. For example, based on input information input by the buyer user 11 on the order sheet creation screen displayed by the terminal apparatus 101 under the control of the display control unit 403, the first registration unit 404 registers the information of the order sheet in the issued order sheet DB 501.

The second registration unit 405 executes a second registration process of registering the information of a second type of form (e.g., the invoice) based on input information input on an input screen displayed by the terminal apparatus 102 under the control of the display control unit 403 to receive input of the information of the second type of form. For example, based on input information input by the supplier user 21 on the invoice creation screen displayed by the terminal apparatus 102 under the control of the display control unit 403, the second registration unit 405 registers the information of the invoice in the issued invoice DB 503. The second registration unit 405 further registers the notification information input on the notification information registration screen in the issued invoice DB 503 in association with the information of the invoice.

The information transmission unit 406 executes an information transmission process of transmitting various information to the terminal apparatus 101, the terminal apparatus 102, or the core system 3, for example. For instance, in response to receipt of an order sheet transmission request from the buyer user 11, the information transmission unit 406 transmits an electronic mail for displaying the order sheet receipt screen to the terminal apparatus 102 used by the supplier user 21. Further, in response to receipt of an invoice transmission request from the supplier user 21, the information transmission unit 406 transmits an electronic mail for displaying the invoice receipt screen to the terminal apparatus 101 used by the buyer user 11.

The matching unit 407 executes a matching process of performing matching between the information of an invoice and the information of an order sheet corresponding to the invoice, and registers the matching result in the received invoice DB 504, for example.

A functional configuration of the terminal apparatus 101 will be described.

With the CPU 301 in FIG. 3, for example, the terminal apparatus 101 executes a particular program, such as a web browser or an application program (hereinafter referred to as the application) functioning as a web browser, to implement the functional configuration as illustrated in FIG. 4. In the example of FIG. 4, the terminal apparatus 101 includes a communication unit 411, a display unit 412, and an operation reception unit 413, for example. At least part of these functional units may be implemented by hardware.

The communication unit 411 executes a communication process of connecting the terminal apparatus 101 to the communication network 2 with the network I/F 308, for example, and communicating with the transaction management system 100 or the core system 3, for example.

The display unit 412, which is implemented by the web browser executed by the CPU 301, for example, executes a display process of displaying the web page provided by the display control unit 403 of the transaction management system 100, for example.

The operation reception unit 413, which is implemented by the web browser executed by the CPU 301, for example, receives an input operation performed by the buyer user 11 on the web page displayed by the display unit 412, for example.

A functional configuration of the terminal apparatus 102 will be described.

With the CPU 301 in FIG. 3, for example, the terminal apparatus 102 executes a particular program, such as a web browser or an application functioning as a web browser, to implement the functional configuration as illustrated in FIG. 4. In the example of FIG. 4, the terminal apparatus 102 includes a communication unit 421, a display unit 422, and an operation reception unit 423, for example. The respective functions of the communication unit 421, the display unit 422, and the operation reception unit 423 are similar to those of the communication unit 411, the display unit 412, and the operation reception unit 413 of the terminal apparatus 101, and thus description thereof will be omitted here.

It is assumed in the embodiment that the core system 3 is an external system outside the information processing system 1, and thus the core system 3 is not involved in the processes of an information processing method of the embodiment. Therefore, description of the core system 3 will be omitted here.

A procedure of the processes of the information processing method (e.g., a transaction management method) of the embodiment will be described.

An ordering process of the embodiment will first be described.

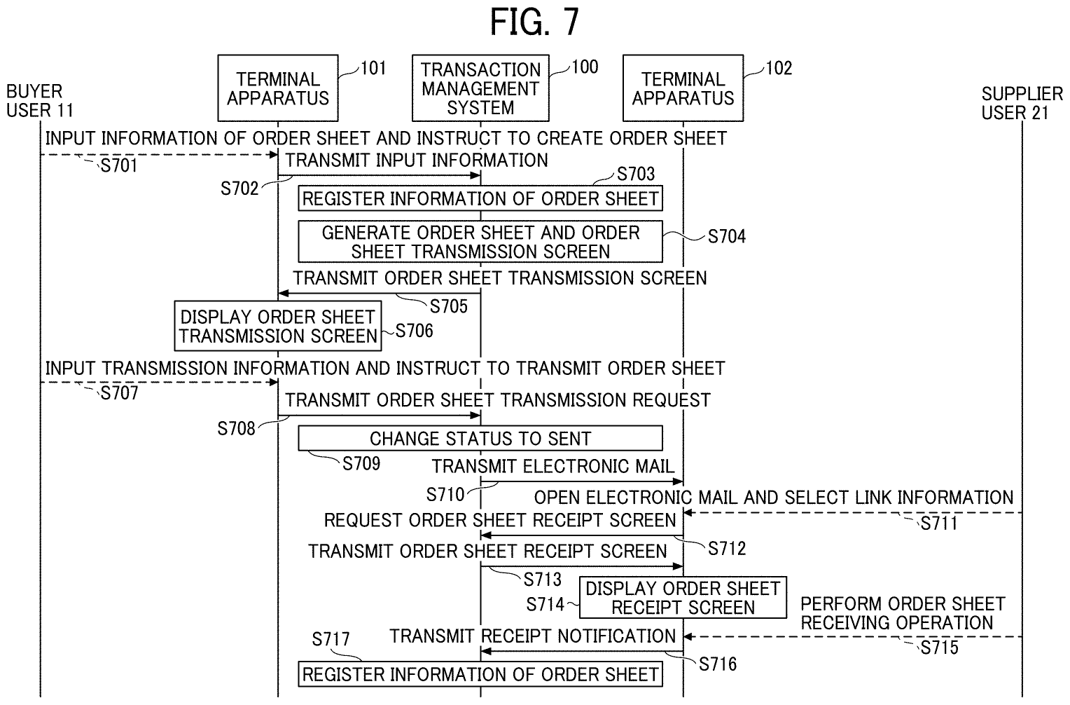

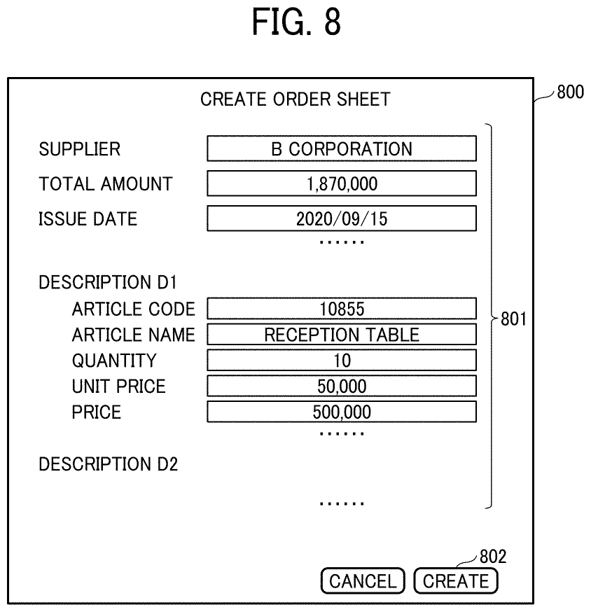

FIG. 7 is a sequence diagram illustrating an example of the ordering process of the embodiment. FIG. 7 illustrates an example of the ordering process executed by the information processing system 1 when the buyer user 11 (i.e., the first user) registers an order sheet in the transaction management system 100 with the terminal apparatus 101. It is assumed here that, at the beginning of the ordering process illustrated in FIG. 7, an order sheet creation screen 800 as illustrated in FIG. 8, for example, is displayed by the buyer user 11 with the terminal apparatus 101. The order sheet creation screen 800 is provided by the display control unit 403 of the transaction management system 100.

At step S701, the buyer user 11 inputs particular information 801 on the order sheet creation screen 800 and selects a CREATE button 802 to instruct the transaction management system 100 to create an order sheet.

At step S702, in response to receipt of the operation of selecting the CREATE button 802, the operation reception unit 413 of the terminal apparatus 101 transmits the information 801 input by the buyer user 11 (i.e., first input information) to the transaction management system 100.

At step S703, based on the information 801 received from the terminal apparatus 101, the first registration unit 404 of the transaction management system 100 registers the information of the order sheet in the issued order sheet DB 501a by setting the status of the information to “temporarily saved.” The information of the order sheet is an example of the information of the first type of form.

At step S704, the display control unit 403 of the transaction management system 100 generates the order sheet and the order sheet transmission screen based on the information of the order sheet registered in the issued order sheet DB 501a.

At step S705, the display control unit 403 transmits the generated order sheet transmission screen to the terminal apparatus 101.

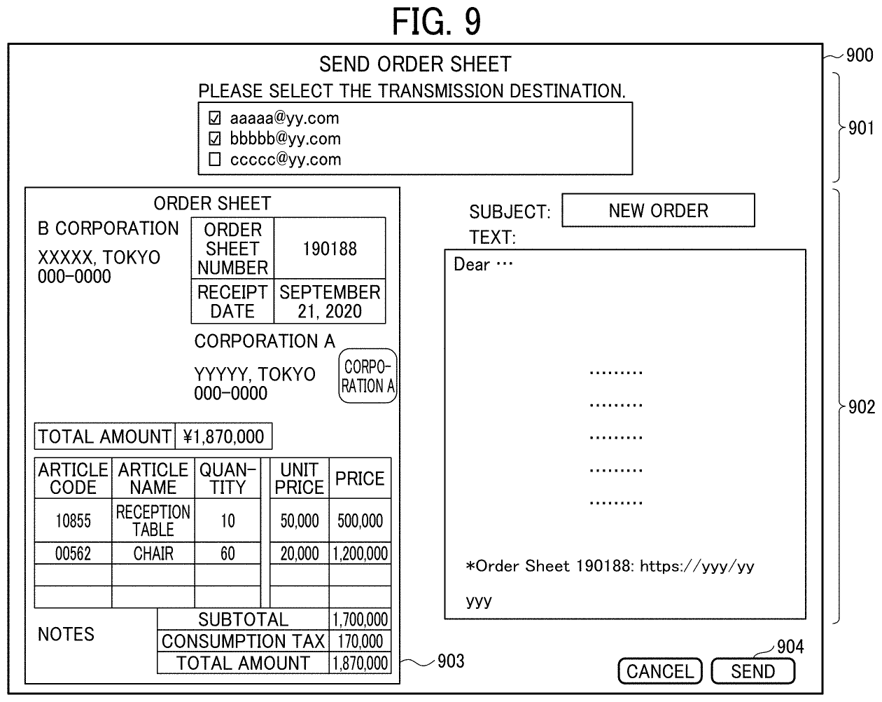

At step S706, the display unit 412 of the terminal apparatus 101 displays an order sheet transmission screen 900 as illustrated in FIG. 9, for example, on the display 306, for example.

At step S707, the buyer user 11 selects the electronic mail address of the transmission destination from a transmission information input field 901 in the order sheet transmission screen 900, and edits the content of an electronic mail information input field 902 as necessary. The buyer user 11 further checks an order sheet image 903. If there is no problem with the content of the order sheet, the buyer user 11 selects a SEND button 904 to instruct the terminal apparatus 101 to transmit the order sheet.

At step S708, in response to receipt of the operation of selecting the SEND button 904, the operation reception unit 413 of the terminal apparatus 101 transmits an order sheet transmission request to the transaction management system 100 to request the transmission of the order sheet.

At step S709, in response to receipt of the order sheet transmission request from the terminal apparatus 101, the first registration unit 404 of the transaction management system 100 changes the status of the information of the order sheet registered in the issued order sheet DB 501a to “sent” from “temporarily saved.”

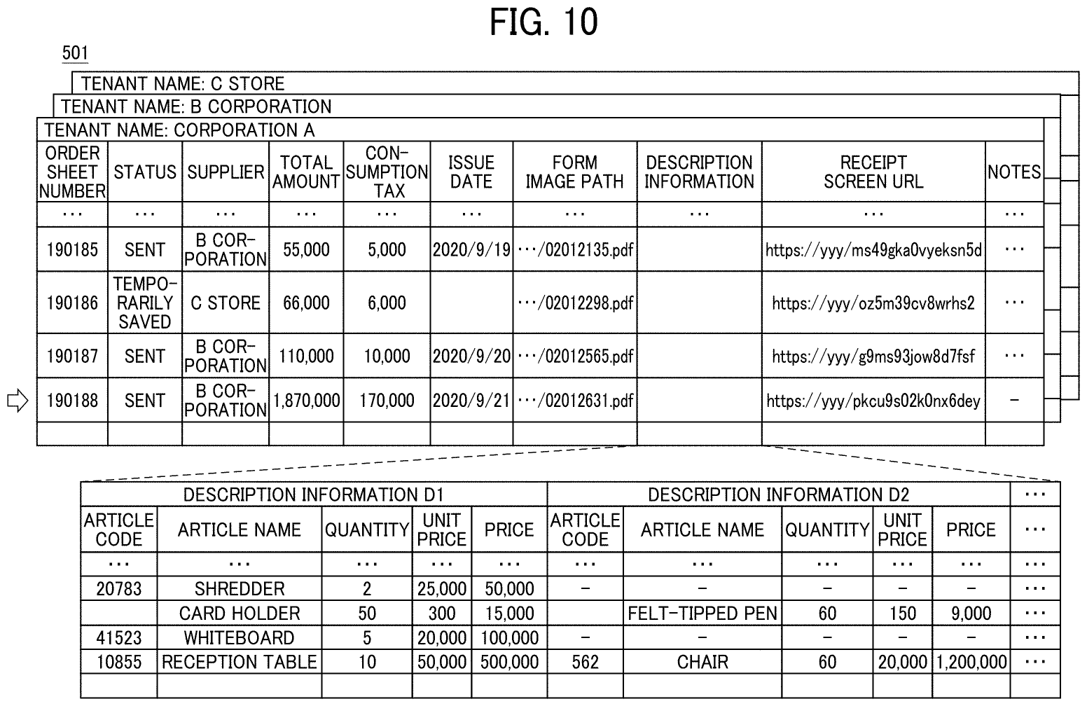

FIG. 10 is a diagram illustrating an example of the issued order sheet DB 501 of the embodiment. In the example of FIG. 10, the issued order sheet DB 501 includes information items “order sheet number,” “status,” “supplier,” “total amount,” “consumption tax,” “issue date,” “form image path,” “description information,” “receipt screen uniform resource locator (URL),” and “notes,” for example.

The item “order sheet number” represents an identification number for identifying the information of the order sheet. For example, when registering the information of a new order sheet in the issued order sheet DB 501a at step S703 in FIG. 7, the first registration unit 404 assigns an order sheet number “190188” to the order sheet and adds the assigned order sheet number “190188” to the information of the order sheet. The item “status” is information representing the status of the information of the order sheet. For instance, the example of FIG. 10 indicates that the information of the order sheet assigned with the order sheet number “190188” is in the “sent” status. The item “supplier” is information representing the name of the supplier, for example. The item “total amount” is information representing the total amount described in the order sheet. The item “consumption tax” is information representing the amount of the consumption tax on the total amount. The item “issue date” is information representing the issue date of the order sheet.

The item “form image path” is information representing the storage location and the file name of the order sheet image 903 as illustrated in FIG. 9, for example. The item “description information” includes one or more description information items, such as description information D1 and description information D2, each of which includes items such as article code, article name, quantity, unit price, and price for each article, as illustrated in FIG. 10. The item “receipt screen URL” is the information of the URL for the supplier user 21 to display the order sheet receipt screen.

Referring back to FIG. 7, the description of the sequence diagram illustrating the ordering process will be continued.

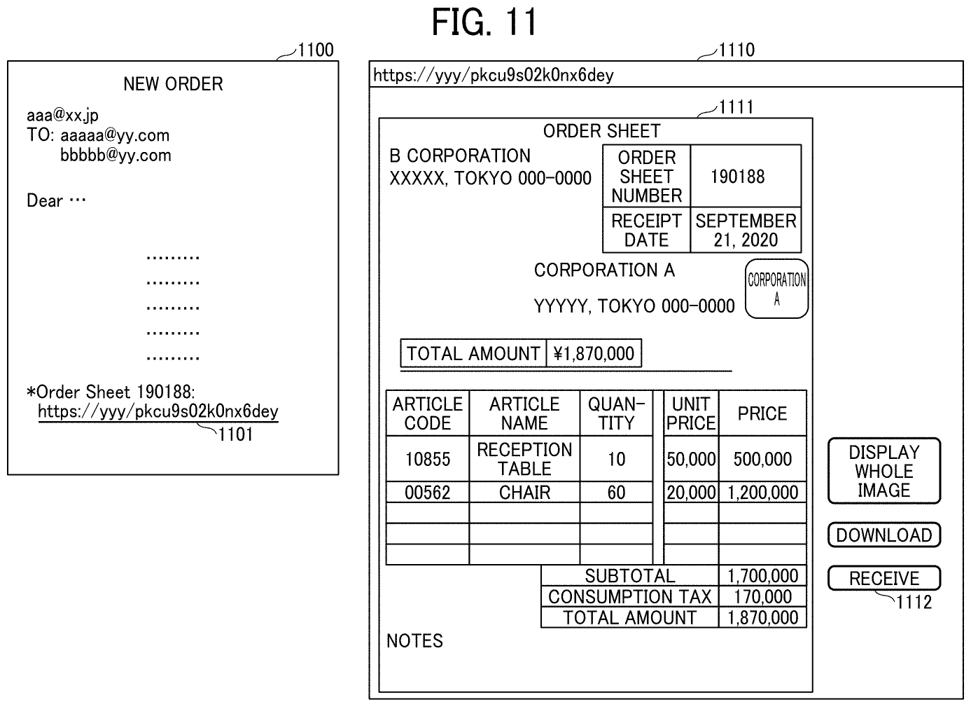

At step S710, the information transmission unit 406 of the transaction management system 100 transmits an electronic mail 1100 as illustrated in FIG. 11, for example, to the electronic mail address of the transmission destination received on the order sheet transmission screen 900.

At step S711, the supplier user 21 opens the electronic mail 1100 as illustrated in FIG. 11, for example, and selects link information 1101. Then, the information processing system 1 executes the processes of step S712 and the subsequent steps.

At steps S712 to S714, the display unit 422 of the terminal apparatus 102 acquires an order sheet receipt screen 1110 as illustrated in FIG. 11, for example, from the acquisition site represented by the link information 1101, and displays the acquired order sheet receipt screen 1110 on the display 306, for example. In the example of FIG. 11, the order sheet receipt screen 1110 displays an order sheet image 1111, a DISPLAY WHOLE IMAGE button, a DOWNLOAD button, and a RECEIVE button 1112.

At step S715, the supplier user 21 performs an operation of receiving the order sheet on the order sheet receipt screen 1110, and the information processing system 1 executes the processes of steps S716 and S717. The supplier user 21 performs the operation of receiving the order sheet by checking the content of the order with the order sheet image 1111 and selecting the RECEIVE button 1112.

At step S716, the operation reception unit 423 of the terminal apparatus 102 transmits a receipt notification to the transaction management system 100 to notify that the operation of receiving the order sheet performed by the supplier user 21 has been received.

At step S717, the second registration unit 405 of the transaction management system 100 acquires the information of the order sheet corresponding to the order sheet number “190188,” for example, from the issued order sheet DB 501 as illustrated in FIG. 10 (i.e., the issued order sheet DB 501a of the buyer 11), and registers the acquired information of the order sheet in the received order sheet DB 502b of the supplier 20.

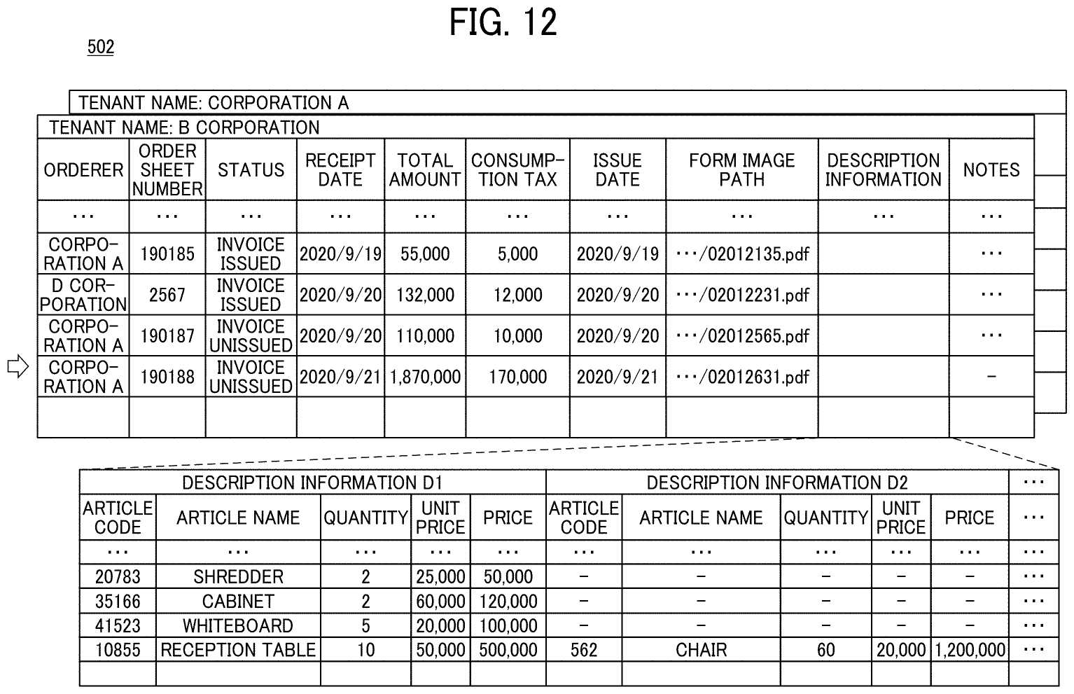

FIG. 12 is a diagram illustrating an example of the received order sheet DB 502 of the embodiment. In FIG. 12, information items such as “order sheet number,” “total amount,” “consumption tax,” “issue date,” “form image path,” “description information,” and “notes” included in the information items in the received order sheet DB 502 are copied from the issued order sheet DB 501 by the second registration unit 405. The information of an item “orderer” is acquired from the tenant name in the issued order sheet DB 501 as the data acquisition source and added to the received order sheet DB 502 by the second registration unit 405, for example. The information of the item “status” is set to “invoice unissued” by the second registration unit 405.

With the above-described processes, the information of the order sheet created by the buyer user 11 is registered in the received order sheet DB 502b of the supplier 20.

An invoicing process of the embodiment will be described.

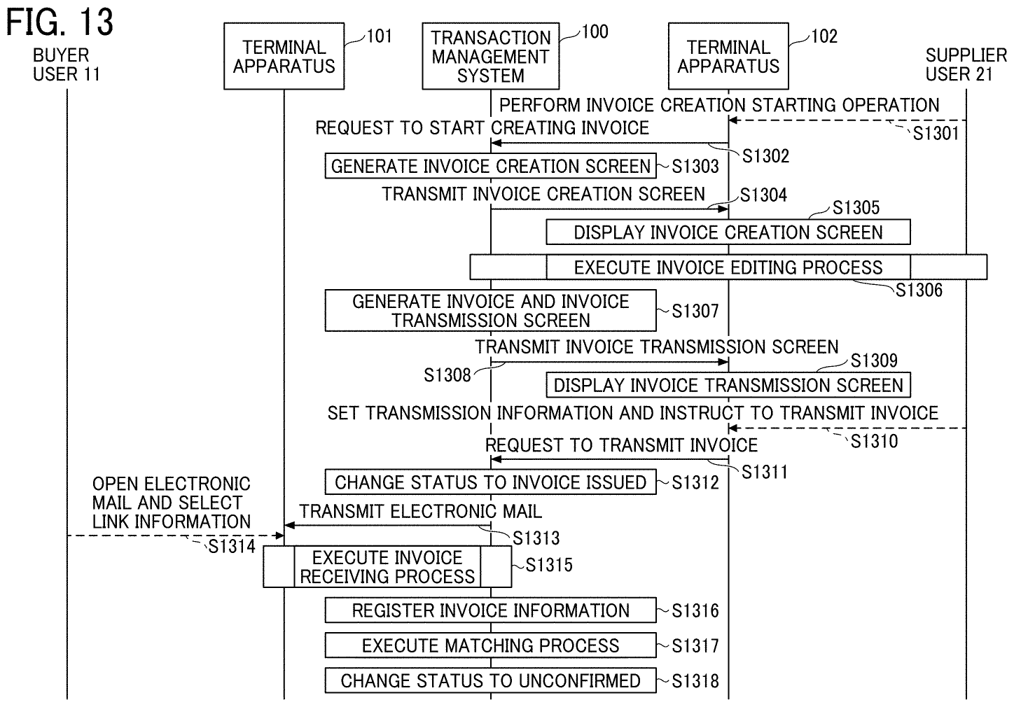

FIG. 13 is a sequence diagram illustrating an example of the invoicing process of the embodiment. FIG. 13 illustrates an example of the invoicing process executed by the information processing system 1 when the supplier user 21 (i.e., the second user) registers an invoice in the transaction management system 100 with the terminal apparatus 102. It is assumed here that the ordering process described above with FIG. 7 has been executed at the beginning of the invoicing process illustrated in FIG. 13.

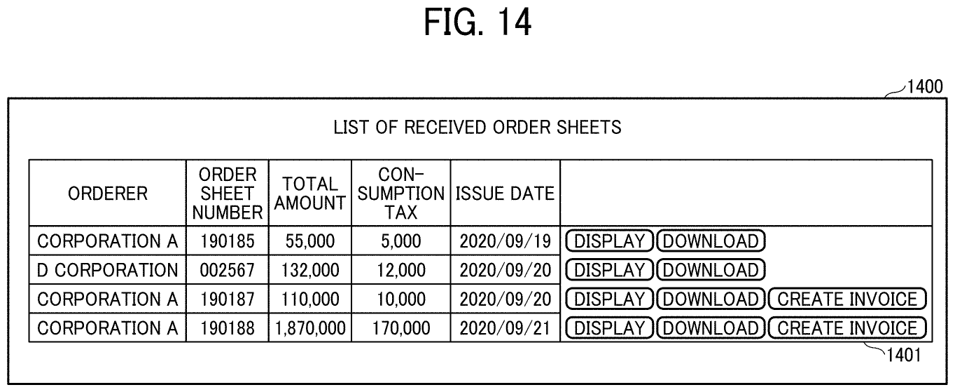

At step S1301, the supplier user 21 performs an operation of starting the creation of the invoice. For example, the supplier user 21 displays a received order sheet list screen 1400 as illustrated in FIG. 14 and selects a CREATE INVOICE button 1401 to perform the operation of starting the creation of the invoice.

At step S1302, in response to receipt of the operation of starting the creation of the invoice, the operation reception unit 423 of the terminal apparatus 102 transmits an invoice creation start request to the transaction management system 100.

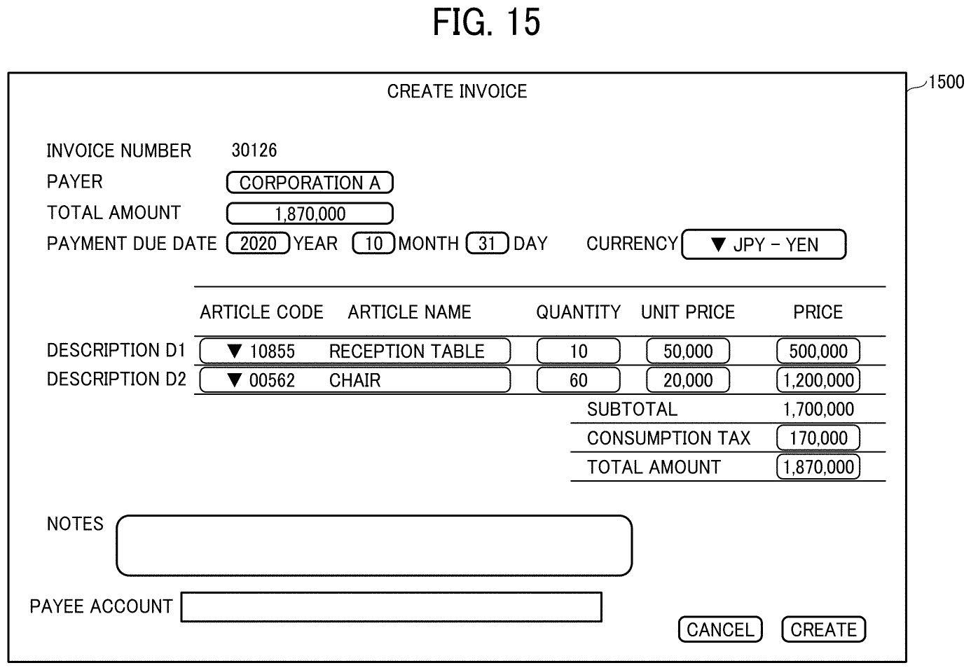

At step S1303, in response to receipt of the invoice creation start request, the display control unit 403 of the transaction management system 100 generates an invoice creation screen 1500 (an example of an input screen) as illustrated in FIG. 15, for example.

At step S1304, the display control unit 403 transmits the generated invoice creation screen 1500 to the terminal apparatus 102, which has requested to start the creation of the invoice. The display control unit 403 acquires the information to be displayed on the invoice creation screen 1500 from the received order sheet DB 502b with the order sheet number of the received order sheet selected on the received order sheet list screen 1400 by the supplier user 21.

At step S1305, the display unit 422 of the terminal apparatus 102 displays the invoice creation screen 1500 on the display 306, for example.

As illustrated in FIG. 16, for example, it is assumed here that the supplier user 21 is able to change article quantity and unit price information 1601 on the invoice creation screen 1500. In this case, if the supplier user 21 changes the article quantity and unit price information 1601, the display control unit 403 of the transaction management system 100 automatically recalculates and updates price information 1602 and a total amount 1603.

Further, in response to the change of the article quantity and unit price information 1601 by the supplier user 21, the display control unit 403 automatically inputs a message such as “The content of the order has been changed. Please check the notification information,” for example, in a note field 1604. As an alternative example, the message in the note field 1604 may be input by the supplier user 21.

Further, for example, the supplier user 21 inputs the account information of the supplier 20 in a payee account input field 1605. As an alternative example, the display control unit 403 may acquire the account information of the supplier 20 from the tenant management information 600 and set the acquired account information in the payee account input field 1605.

Further, as a modified example, the subtotal or the total amount in the price information 1602 on the invoice creation screen 1500 may be changed. For example, the supplier user 21 may change the total amount in the price information 1602 to “1,900,000” from “1,980.000” on the invoice creation screen 1500. In this case, the display control unit 403 may display the difference “80,000” between “1,900,000” and “1,980,000” in a space between the total amount and the consumption tax as the amount of discount, for example.

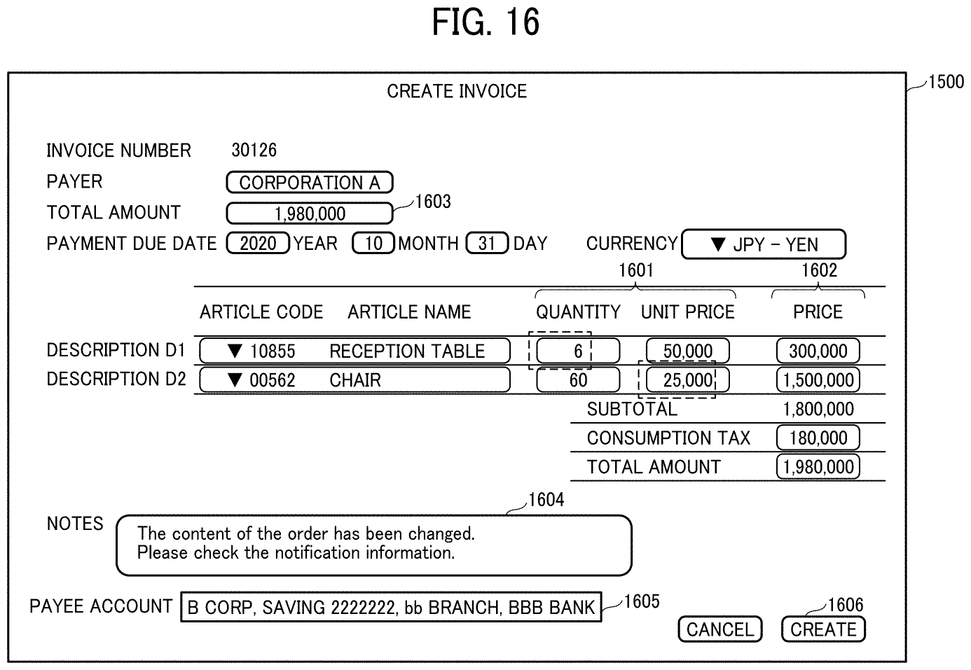

At step S1306, the information processing system 1 executes an invoice editing process as illustrated in FIG. 17, for example.

FIG. 17 is a flowchart illustrating an example of the invoice editing process of the embodiment.

At step S1701, the display control unit 403 of the transaction management system 100 receives input of item values (i.e., second input information). For example, the display control unit 403 receives the input operation performed by the supplier user 21 on the invoice creation screen 1500 described above with FIG. 16.

In response to selection of a CREATE button 1606 on the invoice creation screen 1500 in FIG. 16 (YES at step S1702), the display control unit 403 executes the processes of step S1703 and the subsequent steps.

At step S1703, the display control unit 403 executes the processes of steps S1704 to S1707 on each of input items corresponding to the item values input at step S1701.

At step S1704, the display control unit 403 compares the item value of the input item before and after the change.

At step S1705, the display control unit 403 determines whether the pre-change item value matches the post-change item value. If it is determined that the pre-change item value does not match the post-change item value (NO at step S1705), the display control unit 403 proceeds to the process of step S1706. If it is determined that the pre-change item value matches the post-change item value (YES at step S1705), the display control unit 403 skips the process of step S1706.

At step S1706, the display control unit 403 determines whether the post-change item value not matching the pre-change item value has been changed by the supplier user 21. If it is determined that the post-change item value has been changed by the supplier user 21 (YES at step S1706), the display control unit 403 proceeds to the process of step S1707. If it is determined that the post-change item value has not been changed by the supplier user 21 (NO at step S1706), the display control unit 403 skips the process of step S1707.

At step S1707, the display control unit 403 identifies the input item corresponding to the post-change item value changed by the supplier user 21 as the input item for which the notification information is to be input.

At step S1708, the display control unit 403 determines whether the input item identified at step S1707 exists. If it is determined that the input item exists (YES at step S1708), the display control unit 403 proceeds to the process of step S1709. If it is determined that the input item does not exist (NO at step S1708), the display control unit 403 completes the invoice editing process of FIG. 17.

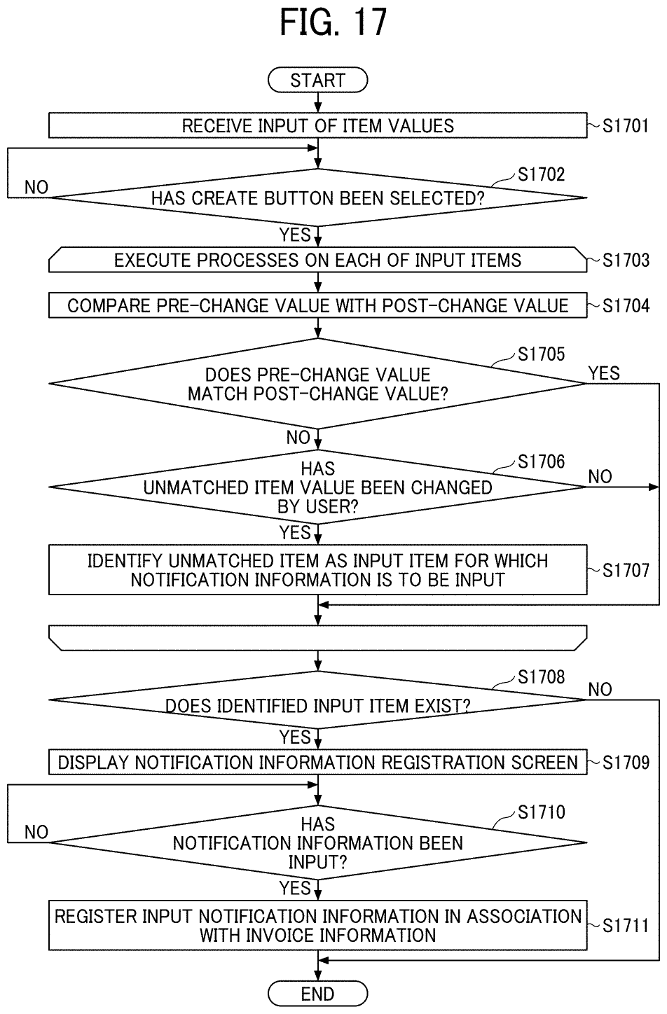

At step S1709, the display control unit 403 causes the terminal apparatus 102 to display a notification information registration screen 1800 as illustrated in FIG. 18, for example.

FIG. 18 illustrates an example of the notification information registration screen of the embodiment. In the example of FIG. 18, with the selection of a tab 1801 corresponding to the changed input item on the notification information registration screen 1800, the supplier user 21 is able to perform processes such as inputting the reason for the change in the input item, selecting a document to attach, and inputting comments. For example, if the supplier user 21 selects “stockout” as the reason for the change from multiple choices displayed in a selection choice field 1802 for selecting the reason for the change, “stockout” is displayed in a selected choice field 1803 as the selected reason for the change. Thereby, the supplier user 21 is able to set the reason for the change to “stockout.”

Further, with the selection of a SELECT FILE button 1804, the supplier user 21 is able to select a file to attach an attached document to the notification information. The supplier user 21 is also able to input comments in a comment field 1805. Further, with the selection of an OK button 1705, the supplier user 21 is able to complete the input of the notification information. The comment field 1805 may be provided for each changed input item, or a single comment field 1805 may be provided for a plurality of changed input items on the notification information registration screen 1800.

If it is determined at step S1710 that the input of the notification information has been completed (YES at step S1710), the display control unit 403 proceeds to the process of step S1711.

At step S1711, the second registration unit 405 of the transaction management system 100 registers the notification information input on the notification information registration screen 1800 in the issued invoice DB 503b of the supplier 20 in association with the information of the invoice created on the invoice creation screen 1500.

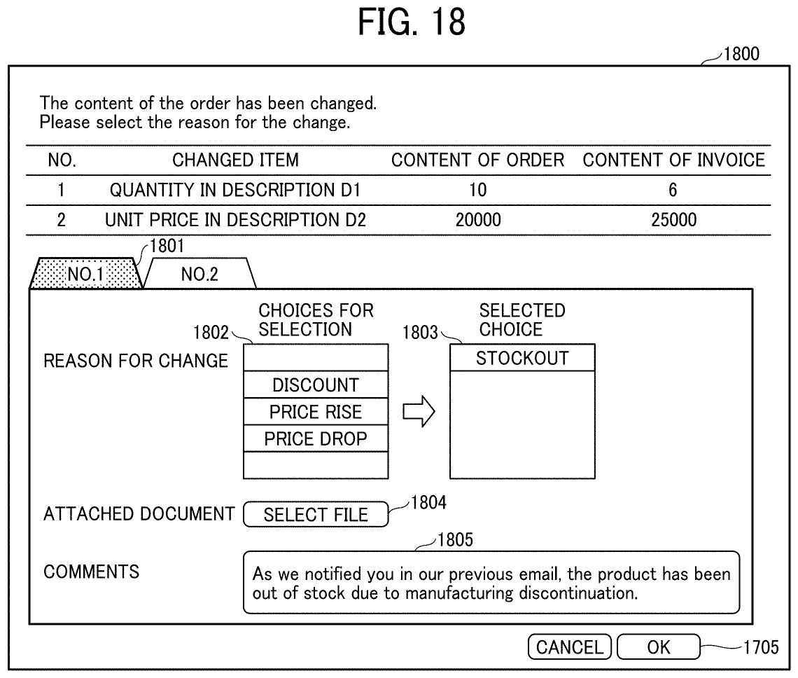

As a modified example, the information processing system 1 may execute an invoice editing process as illustrated in FIG. 19 at step S1306 in FIG. 13.

FIG. 19 is a flowchart illustrating another example of the invoice editing process of the embodiment. Herein, detailed description of processes in FIG. 19 similar to those described above with FIG. 17 will be omitted.

At step S1901, the display control unit 403 of the transaction management system 100 receives input of item values.

At step S1902, the display control unit 403 determines whether the input item values have been confirmed. For example, if an enter key is pressed, or if an area other than input fields and selection buttons is clicked, the display control unit 403 may determine that the input item values have been confirmed. If it is determined that the input item values have been confirmed (YES at step S1902), the display control unit 403 proceeds to the process of step S1903.

At step S1903, the display control unit 403 compares each of the item values of the input items before and after the change.

At step S1904, the display control unit 403 determines whether the pre-change item value matches the post-change item value. If it is determined that the pre-change item value does not match the post-change item value (NO at step S1904), the display control unit 403 proceeds to the process of step S1905. If it is determined that the pre-change item value matches the post-change item value (YES at step S1904), the display control unit 403 completes the invoice editing process of FIG. 19.

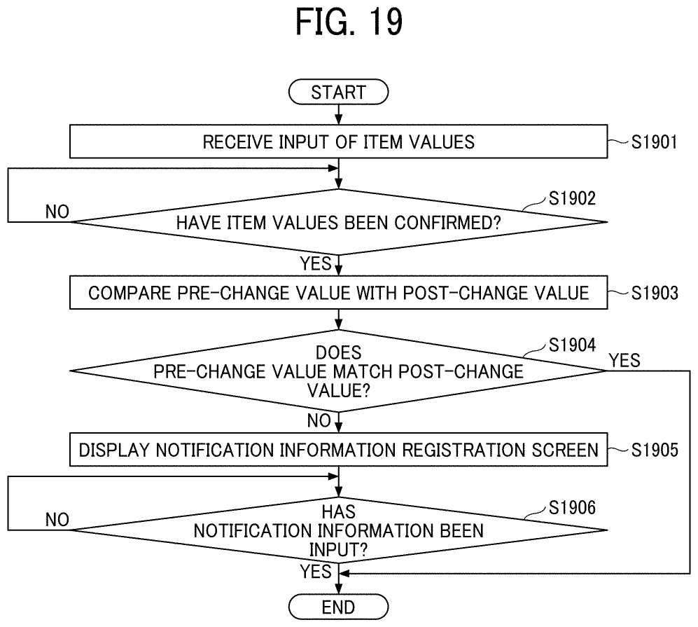

At step S1905, the display control unit 403 causes the terminal apparatus 102 to display a notification information registration screen 2000 as illustrated in FIG. 20, for example.

FIG. 20 illustrates another example of the notification information registration screen of the embodiment. In the invoice editing process of FIG. 19, the notification information registration screen 2000 as illustrated in FIG. 20 is displayed each time an item value changeable by the supplier user 21 is changed. Therefore, the notification information registration screen 2000 does not require tabs such as those on the notification information registration screen 1800 illustrated in FIG. 18. As a variation of the method of enabling the supplier user 21 to select the reason for the change, the notification information registration screen 2000 displays checkboxes 2001 to enable the selection of the reason for the change. The supplier user 21 is able to complete the input of the notification information by selecting an OK button 2002.

If it is determined at step S1906 that the input of the notification information has been completed (YES at step S1906), the display control unit 403 completes the invoice editing process of FIG. 19.

If an item value changeable by the supplier user 21 is changed on the invoice creation screen 1500 as illustrated in FIG. 16, for example, the display control unit 403 executes the invoice editing process of FIG. 19. Further, in response to the selection of the CREATE button 1606 on the invoice creation screen 1500 in FIG. 16, the second registration unit 405 registers the notification information input on the notification information registration screen 2000 in the issued invoice DB 503b of the supplier 20 in association with the information of the invoice created on the invoice creation screen 1500.

Referring back to FIG. 13, the description of sequence diagram illustrating the invoicing process will be continued.

At step S1307, the display control unit 403 of the transaction management system 100 generates the invoice and the invoice transmission screen based on the information registered in the issued invoice DB 503b by the second registration unit 405.

At step S1308, the display control unit 403 transmits the generated invoice transmission screen to the terminal apparatus 102.

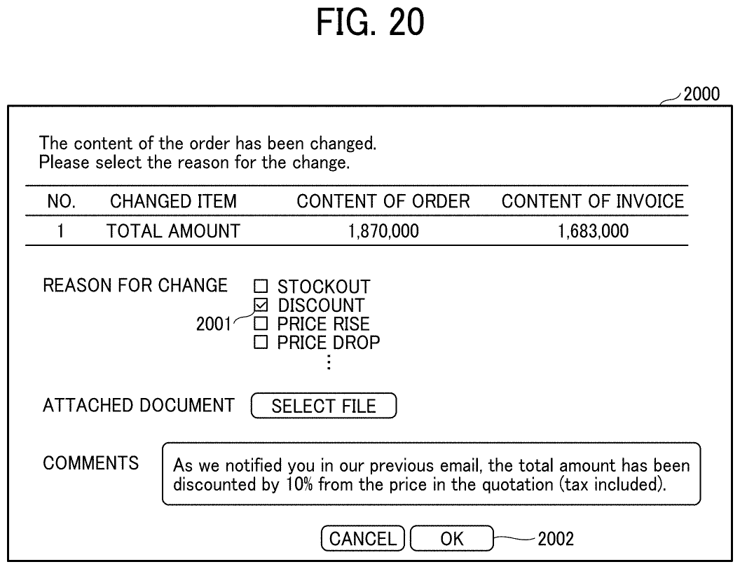

For example, the display control unit 403 creates an invoice 2100 as illustrated in FIG. 21 with the information input on the invoice creation screen 1500 as illustrated in FIG. 16. In this case, the quantity and the unit price have been changed on the invoice creation screen 1500. Therefore, a note field 2101 in the invoice 2100 includes a message for prompting the supplier user 21 to check the notification information.

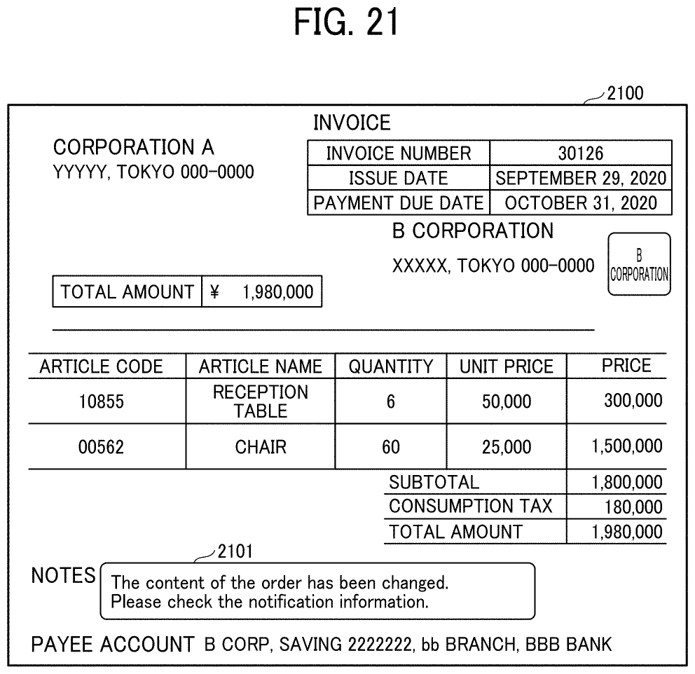

At step S1309, the display unit 422 of the terminal apparatus 102 displays an invoice transmission screen 2200 as illustrated in FIG. 22, for example, on the display 306, for instance.

At step S1310, the supplier user 21 selects the electronic mail address of the transmission destination from a transmission information input field 2201 in the invoice transmission screen 2200, and edits the content of an electronic mail information input field 2202 as necessary. The supplier user 21 further checks an invoice image 2203. If there is no problem with the content of the invoice, the supplier user 21 selects a SEND button 2204 to instruct the terminal apparatus 102 to transmit the invoice.

At step S1311, in response to receipt of the operation of selecting the SEND button 2204, the operation reception unit 423 of the terminal apparatus 102 transmits an invoice transmission request to the transaction management system 100 to request the transmission of the invoice.

At step S1312, in response to receipt of the invoice transmission request from the terminal apparatus 102, the second registration unit 405 of the transaction management system 100 changes the status of the information of the invoice registered in the issued invoice DB 503b to “invoice issued.”

At step S1313, the information transmission unit 406 of the transaction management system 100 transmits an electronic mail to the electronic mail address of the transmission destination received on the invoice transmission screen 2200.

At step S1314, the buyer user 11 opens the electronic mail and selects link information therefrom. Thereby, at step S1315, an invoice receiving process similar to the order sheet receiving process at steps S712 to S716 in FIG. 7, for example, is executed between the terminal apparatus 101 and the transaction management system 100.

At step S1316, the first registration unit 404 of the transaction management system 100 acquires the information of the invoice created in the above-described processes from the issued invoice DB 503b of the supplier 20, for example, and registers the acquired information of the invoice in the received invoice DB 504a of the buyer 10.

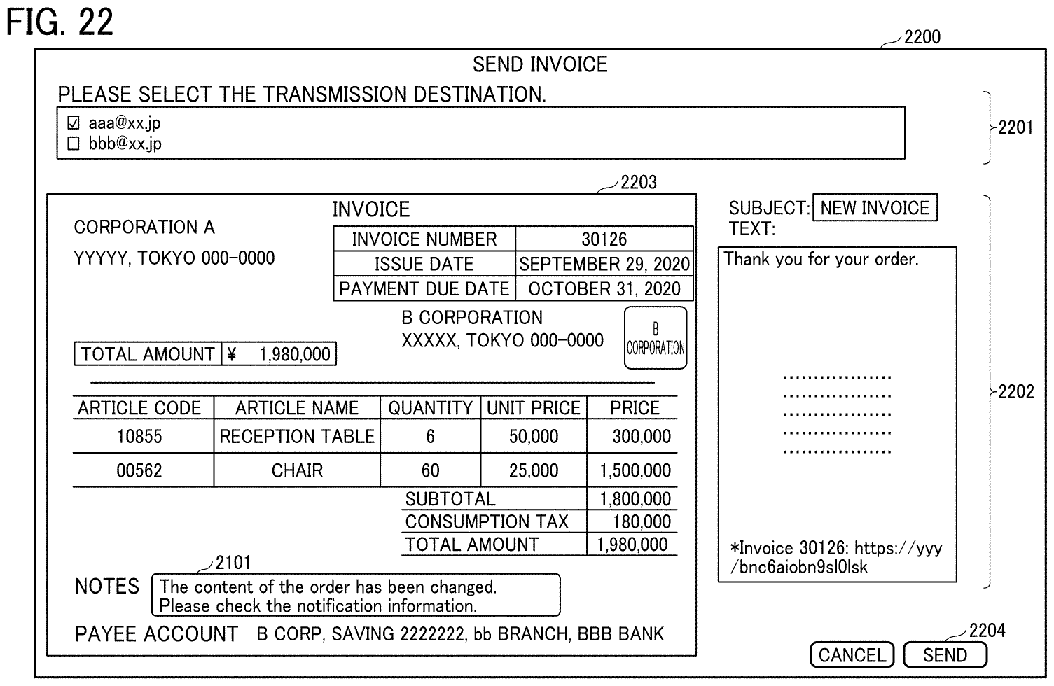

FIG. 23 is a diagram illustrating an example of the issued invoice DB 503 of the embodiment, specifically the image of an example of the issued invoice DB 503b of the supplier 20. In the example of FIG. 23, the issued invoice DB 503b includes information items “payer,” “invoice number,” “order sheet number,” “status,” “total amount,” “consumption tax,” “issue date,” “payment due date,” “payee account,” “form image path,” “description information,” and “notes,” for example.

As for the items “payer,” “total amount,” “consumption tax,” “payment due date,” “payee account,” and “notes,” the second registration unit 405 registers the corresponding information set by the supplier user 21 on the invoice creation screen 1500 as illustrated in FIG. 16, for example, in the issued invoice DB 503b. As for the item “invoice number,” the second registration unit 405 assigns and sets the invoice number to the invoice when registering the information of the invoice in the issued invoice DB 503b, for example. As for the item “form image path,” the second registration unit 405 sets information representing the storage location and the file name of the image of the invoice 2100 as illustrated in FIG. 21, for example.

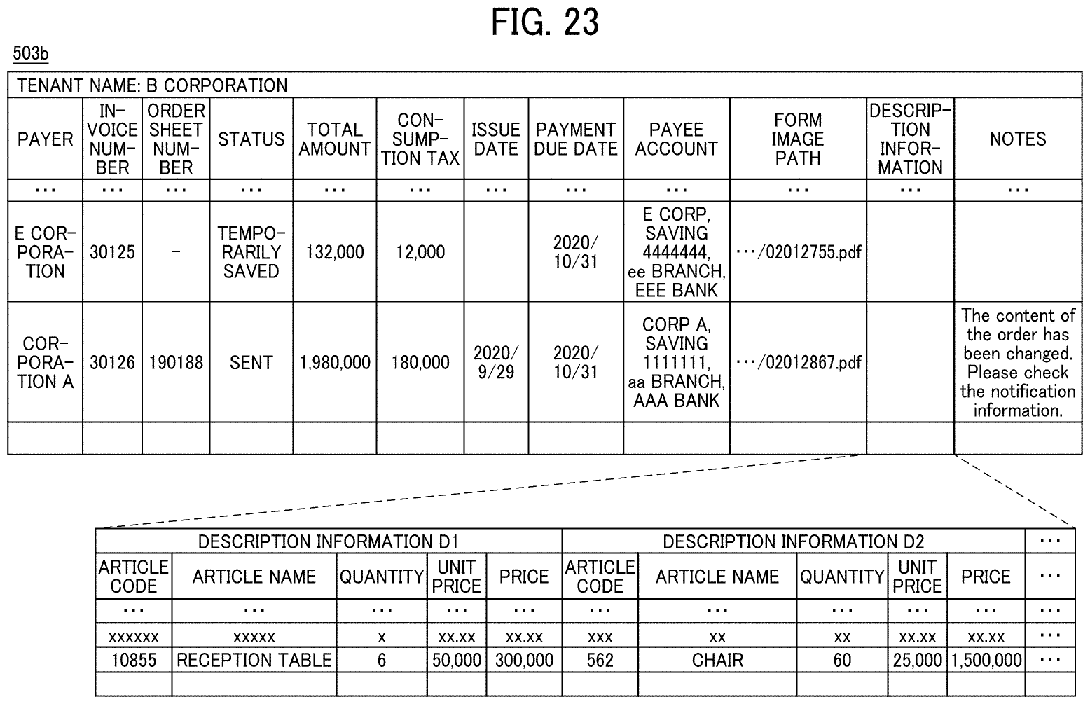

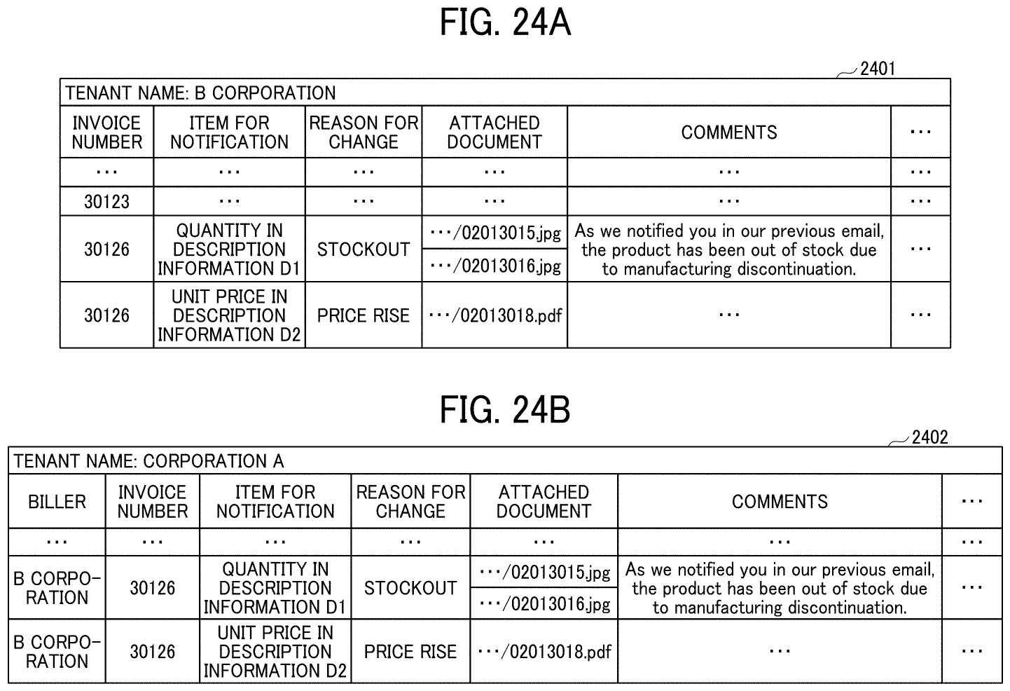

Further, if the notification information is input on the notification information registration screen 1800 in FIG. 18 or the notification information registration screen 2000 in FIG. 20, for example, the second registration unit 405 registers issued notification information 2401 as illustrated in FIG. 24A in the issued invoice DB 503b. The notification information corresponding to the information of the invoice registered in the issued invoice DB 503b illustrated in FIG. 23 is registered in the issued notification information 2401. The information of the invoice and the notification information are associated with each other with the invoice number. In the example of FIG. 24A, the issued notification information 2401 includes information items input on the notification information registration screen 1800 or 2000 such as “item for notification,” “reason for change,” “attached document,” and “comments.” The issued notification information 2401 may be included in the issued invoice DB 503b as illustrated in FIG. 23, for example.

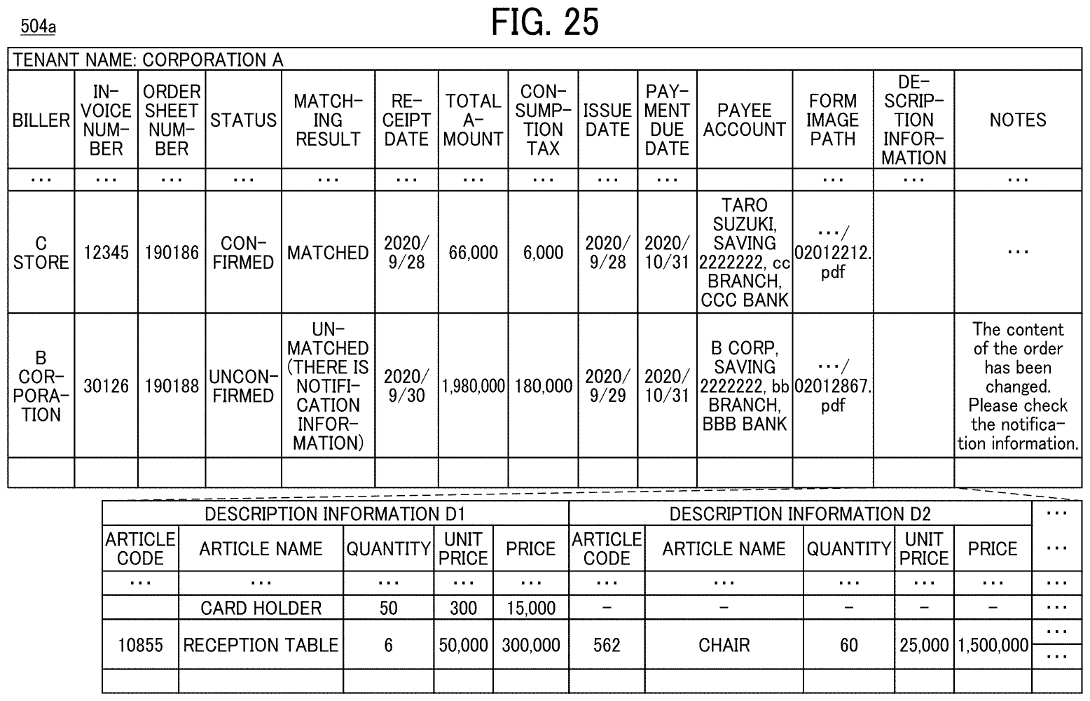

FIG. 25 is a diagram illustrating an example of the received invoice DB 504 of the embodiment, specifically the image of an example of the received invoice DB 504a of the buyer 10. In the example of FIG. 25, the received invoice DB 504a includes information items “biller,” “invoice number,” “order sheet number,” “status.” “matching result,” “receipt date,” “total amount,” “consumption tax,” “issue date,” “payment due date,” “payee account,” “form image path,” “description information,” and “notes,” for example.

As for the items “invoice number,” “order sheet number,” “total amount,” “consumption tax,” “issue date,” “payment due date,” “payee account,” “description information,” and “notes,” the first registration unit 404 copies the corresponding information from the issued invoice DB 503b as illustrated in FIG. 23 to the received invoice DB 504a. As for the item “biller,” the first registration unit 404 acquires the tenant name from the issued invoice DB 503b as illustrated in FIG. 23, for example, and sets the acquired tenant name as the biller. As for the item “status,” the first registration unit 404 sets the status to “unconfirmed.” As for the item “matching result,” the matching unit 407 registers the matching result determined in a later-described matching process. As for the item “receipt date,” the first registration unit 404 sets the date of registration of the information of the invoice in the received invoice DB 504a, for example.

If there is notification information associated with the information of the invoice registered in the received invoice DB 504a, the first registration unit 404 registers the notification information in the received invoice DB 504a in association with the information of the invoice. For example, the first registration unit 404 creates received notification information 2402 as illustrated in FIG. 24B by adding the information of the biller to the issued notification information 2401 as illustrated in FIG. 24A, and registers the created received notification information 2402 in the received invoice DB 504a. The information of the invoice and the notification information are associated with each other with the invoice number.

Referring back to FIG. 13, the description of sequence diagram illustrating the invoicing process will be continued.

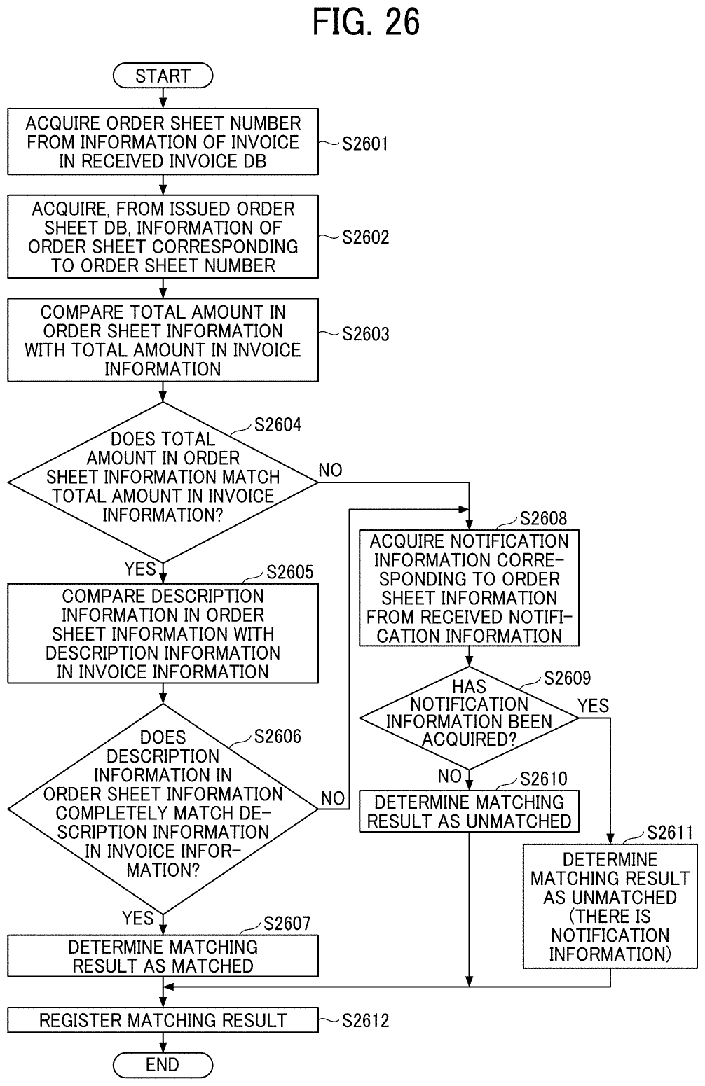

At step S1317, the matching unit 407 of the transaction management system 100 executes a matching process as illustrated in FIG. 26, for example.

FIG. 26 is a flowchart illustrating an example of the matching process of the embodiment. FIG. 26 illustrates an example of the process executed by the matching unit 407 of the transaction management system 100 at step S1317 in FIG. 13.

At step S2601, the matching unit 407 acquires the information of the invoice from the received invoice DB 504a, and acquires the order sheet number included in the acquired information of the invoice. For example, the matching unit 407 acquires the information of the invoice corresponding to the invoice number “30126,” which has been registered in the received invoice DB 504a by the first registration unit 404 at step S1316 in FIG. 13. The matching unit 407 then acquires the order sheet number “190188” included in the acquired information of the invoice.

At step S2602, the matching unit 407 acquires the information of the order sheet corresponding to the acquired order sheet number from the issued order sheet DB 501a. For example, the matching unit 407 acquires the information of the order sheet corresponding to the order sheet number “190188” from the issued order sheet DB 501 as illustrated in FIG. 10 (i.e., the issued order sheet DB 501a of the buyer 11).

At steps S2603 and 2604, the matching unit 407 determines whether the total amount included in the information of the invoice acquired from the received invoice DB 504a matches the total amount included in the information of the order sheet acquired from the issued order sheet DB 501a. If it is determined that the total amount included in the information of the invoice acquired from the received invoice DB 504a matches the total amount included in the information of the order sheet acquired from the issued order sheet DB 501a (YES at step S2604), the matching unit 407 proceeds to the process of step S2605. If it is determined that the total amount included in the information of the invoice acquired from the received invoice DB 504a does not match the total amount included in the information of the order sheet acquired from the issued order sheet DB 501a (NO at step S2604), the matching unit 407 proceeds to the process of step S2608.

At step S2605, the matching unit 407 compares the description information included in the information of the order sheet acquired from the issued order sheet DB 501a with the description information included in the information of the invoice acquired from the received invoice DB 504a. If it is determined at step S2606 that the description information included in the information of the order sheet acquired from the issued order sheet DB 501a completely matches the description information included in the information of the invoice acquired from the received invoice DB 504a (YES at step S2606), the matching unit 407 proceeds to the process of step S2607. If it is determined at step S2606 that the description information included in the information of the order sheet acquired from the issued order sheet DB 501a includes an item that does not match the corresponding item in the description information included in the information of the invoice acquired from the received invoice DB 504a (NO at step S2606), the matching unit 407 proceeds to the process of step S2608.

At step S2607, the matching unit 407 determines the matching result as “matched,” and proceeds to the process of step S2612.

At step S2608, the matching unit 407 acquires the notification information corresponding to the order sheet number acquired at step S2601 from the received invoice DB 504a. For example, the matching unit 407 acquires the notification information registered in the received notification information 2402 in FIG. 24B by the first registration unit 404 at step S1316 in FIG. 13.

At step S2609, the matching unit 407 determines whether the notification information has been acquired (i.e., whether the notification information corresponding to the information of the invoice is registered). If it is determined that the notification information has not been acquired (NO at step S2609), the matching unit 407 proceeds to the process of step S2610. If it is determined that the notification information has been acquired (YES at step S2609), the matching unit 407 proceeds to the process of step S2611.

At step S2610, the matching unit 407 determines the matching result as “unmatched,” and proceeds to the process of step S2612. At step S2611, the matching unit 407 determines the matching result as “unmatched (there is notification information),” and proceeds to the process of step S2612.

At step S2612, the matching unit 407 registers the matching result in the received invoice DB 504a under the item “matching result,” for example (see FIG. 25).

Referring back to FIG. 13, the description of the sequence diagram illustrating the invoicing process will be continued.

At step S1318, the first registration unit 404 of the transaction management system 100 changes the status of the information of the invoice registered in the received invoice DB 504a as illustrated in FIG. 25, for example, to “unconfirmed.”

A checking process of the embodiment will be described.

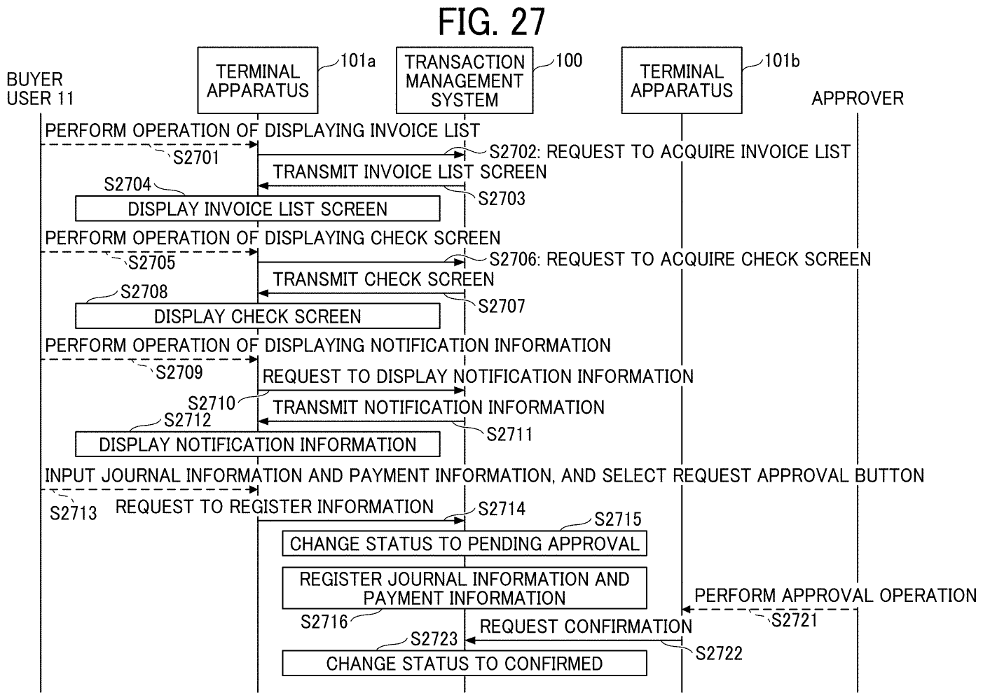

FIG. 27 is a sequence diagram illustrating an example of the checking process of the embodiment. FIG. 27 illustrates an example of the checking process in which, with the terminal apparatus 101, the buyer user 11 (i.e., the first user) confirms the information of the “unconfirmed” invoice registered in the received invoice DB 504a. In the example of FIG. 27, two terminal apparatuses 101 are used by the buyer 10: a terminal apparatus 101a used by one user of the buyer 10 (i.e., the buyer user 11) and a terminal apparatuses 101b used by another user of the buyer 10 acting as an approver. It is assumed here that the invoicing process described above with FIG. 13 has been executed at the beginning of the checking process illustrated in FIG. 27.

At step S2701, the buyer user 11 performs an operation of displaying invoice list. At step S2702, in response to receipt of this operation, the operation reception unit 413 of the terminal apparatus 101a requests the transaction management system 100 to acquire the invoice list.

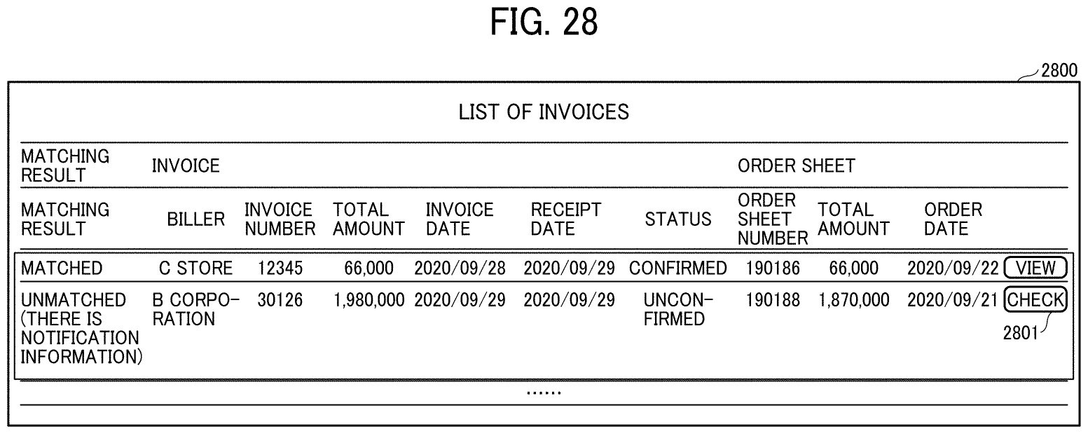

At step S2703, the display control unit 403 of the transaction management system 100 generates an invoice list screen 2800 as illustrated in FIG. 28, for example, and transmits the generated invoice list screen 2800 to the terminal apparatus 101a, which has requested the invoice list. The display control unit 403 generates the invoice list screen 2800 by extracting predetermined information from the received invoice DB 504a as illustrated in FIG. 25, for example.

At step S2704, the terminal apparatus 101a displays the invoice list screen 2800 received from the transaction management system 100.

At step S2705, the operation reception unit 413 of the terminal apparatus 101a receives an operation of displaying a check screen. Then, the information processing system 1 executes the processes of step S2706 and the subsequent steps. At step S2706, in response to receipt of the operation of displaying the check screen, the operation reception unit 413 of the terminal apparatus 101a requests the transaction management system 100 to acquire the check screen. The buyer user 11 performs the operation of displaying the check screen by selecting a CHECK button 2801 on the invoice list screen 2800 as illustrated in FIG. 28, for example.

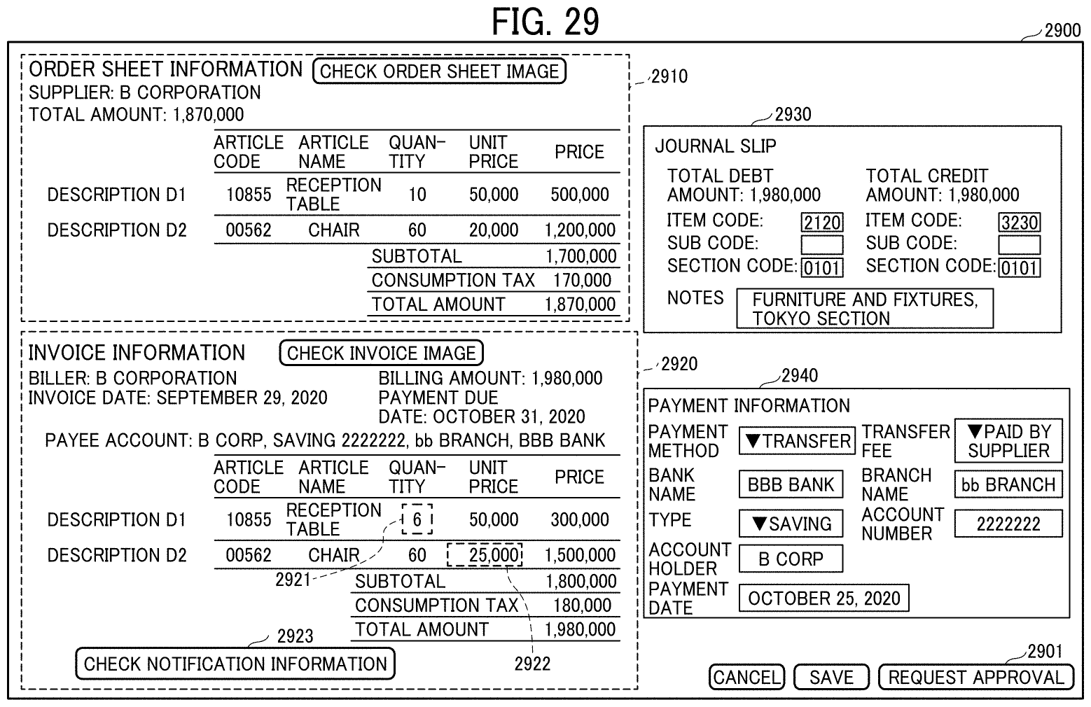

At step S2707, the display control unit 403 of the transaction management system 100 generates a check screen 2900 as illustrated in FIG. 29, for example, and transmits the generated check screen 2900 to the terminal apparatus 101a, which has requested the check screen.

FIG. 29 is a diagram illustrating an example of the check screen of the embodiment. The check screen 2900 includes information such as order sheet information 2910, invoice information 2920, a journal slip 2930, and payment information 2940, for example. For instance, based on the order sheet number displayed on the invoice list screen 2800, the display control unit 403 displays the order sheet information 2910 on the check screen 2900 with the information of the order sheet acquired from the issued order sheet DB 501a.

Further, based on the invoice number displayed on the invoice list screen 2800, the display control unit 403 displays the invoice information 2920 with the information of the invoice acquired from the received invoice DB 504a. Preferably, information 2921 and information 2922 in the invoice information 2920, which are different from the corresponding information in the order sheet information 2910, are displayed in highlight by the display control unit 403. If there is notification information associated with the acquired information of the invoice, the display control unit 403 further displays a CHECK NOTIFICATION INFORMATION button 2923 on the check screen 2900.

The display control unit 403 further displays the journal slip 2930 and the payment information 2940 on the check screen 2900 with a preset template, for example. Part of the information in setting items of the journal slip 2930 and the payment information 2940 may be automatically set by the display control unit 403. In this case, information not automatically set is input by the buyer user 11.

Referring back to FIG. 27, the description of the sequence diagram illustrating the checking process will be continued.

When the buyer user 11 performs an operation of displaying the notification information at step S2709, the operation reception unit 413 of the terminal apparatus 101a requests the transaction management system 100 to display the notification information at step S2710.

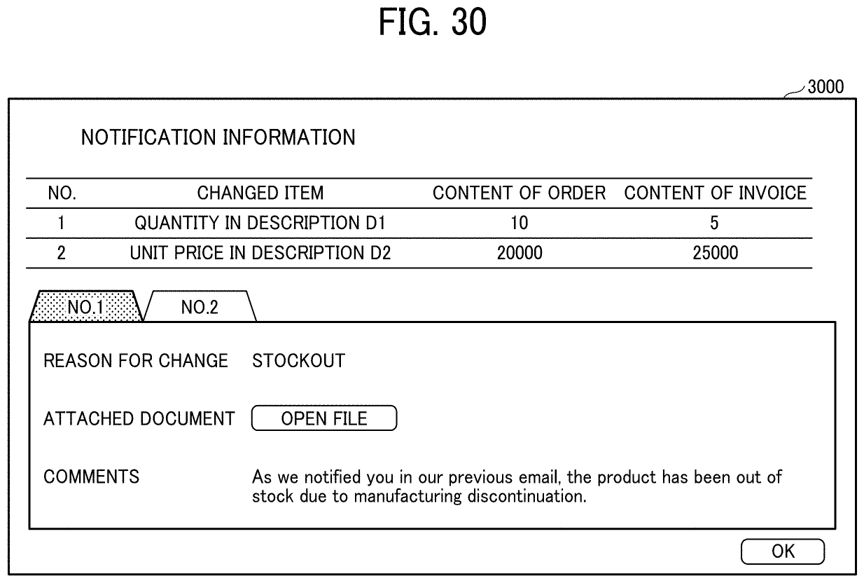

At step S2711, the display control unit 403 of the transaction management system 100 generates notification information 3000 as illustrated in FIG. 30, for example, and transmits the generated notification information 3000 to the terminal apparatus 101a, which has requested the display of the notification information. Thereby, at step S2712, the display unit 412 of the terminal apparatus 101a displays the notification information 3000 on the display 306, for example. The notification information 3000 facilitates the buyer user 11 to determine the validity of the information 2921 and the information 2922 in the invoice information 2920, which are different from the corresponding information in the order sheet information 2910.

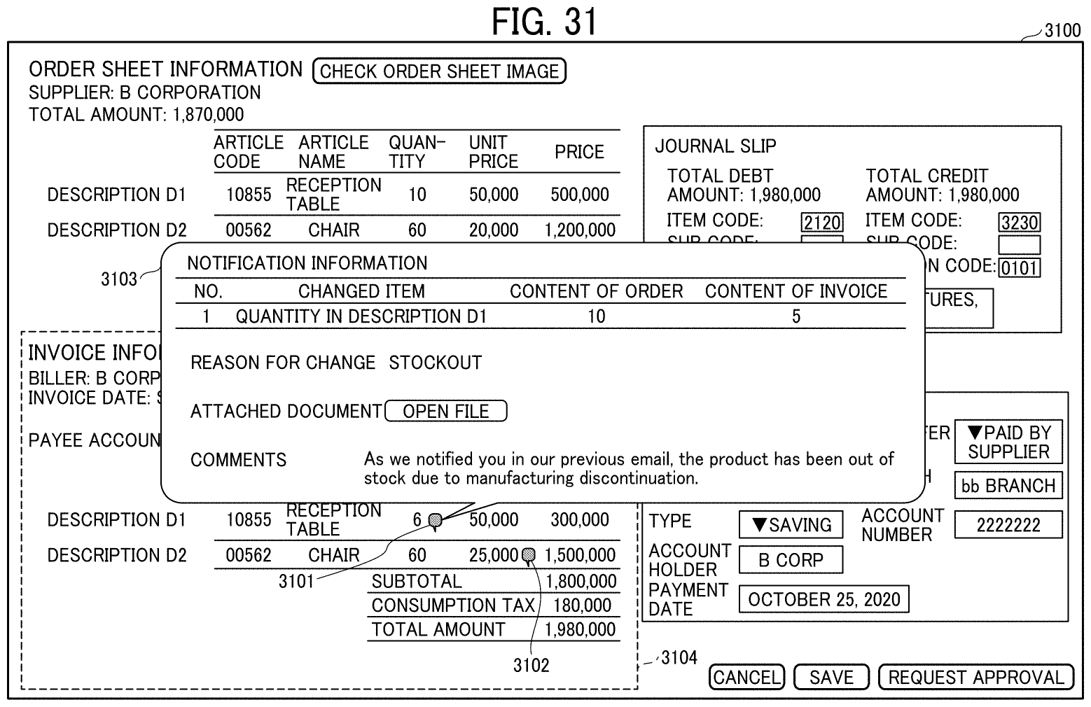

The check screen 2900 illustrated in FIG. 29 is illustrative. For example, at steps S2707 and S2708, the display control unit 403 may generate a check screen 3100 as illustrated in FIG. 31 and cause the terminal apparatus 101a to display the generated check screen 3100. In the example of FIG. 31, the check screen 3100 displays display elements 3101 and 3102 at the differences between the order sheet information and invoice information 3104 to display the notification information corresponding to the differences. For example, the buyer user 11 is able to display notification information 3103 on the check screen 3100 by selecting the display element 3101. The display control unit 403 thus displays, on the check screen 3100, the invoice information 3104 and the notification information 3103 corresponding to the invoice information 3104. The invoice information is an example of the information of the second type of form.

If the buyer user 11 determines from the notification information that the invoice information 2920 is valid, the information processing system 1 executes the processes of step S2713 and the subsequent steps.

At step S2713, the buyer user 11 inputs information such as the journal information and the payment information on the check screen 2900, and selects a REQUEST APPROVAL button 2901 (see FIG. 29). At step S2714, in response to receipt of the selection, the operation reception unit 413 of the terminal apparatus 101a requests the transaction management system 100 to update the received information.

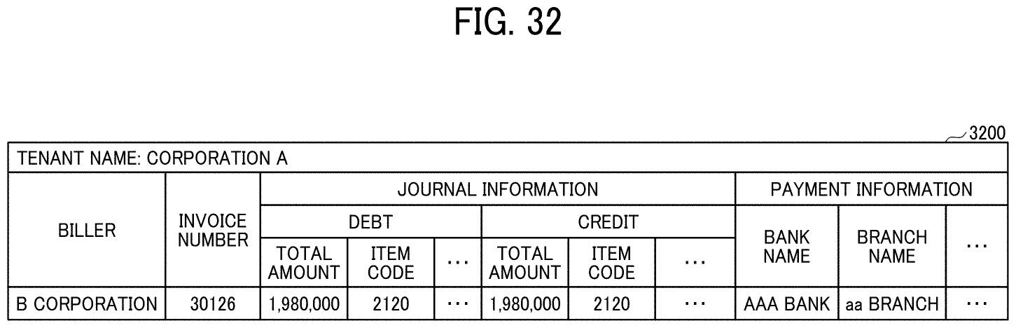

At step S2715, the first registration unit 404 of the transaction management system 100 changes the status of the information of the invoice to be processed to “pending approval” in the received invoice DB 504a as illustrated in FIG. 25, for example. Further, at step S2716, the first registration unit 404 registers the journal information and the payment information acquired from the terminal apparatus 101a in output information 3200 as illustrated in FIG. 32, for example. The output information 3200 is used in the transmission of information to the core system 3 such as an accounting system, a payment system, or an order system, for example.

It is assumed here that, at step S2721, the approver performs an approval operation with the terminal apparatus 101b to approve the information of the invoice in the “pending approval” status registered in the received invoice DB 504a, for example. Thereby, at step S2722, the terminal apparatus 101b transmits a confirmation request to the transaction management system 100.

Although any screen may be used as an approval screen on which the approver performs the approval operation, a screen similar to the check screen 2900 as illustrated in FIG. 29 with the REQUEST APPROVAL button 2901 replaced with an APPROVE button may be applied to the approval screen, for example. The approver may perform the approval operation at a desired time.

At step S2723, the first registration unit 404 of the transaction management system 100 changes the status of the information of the invoice approved by the approver to “confirmed” in the received invoice DB 504a as illustrated in FIG. 25, for example.

The information of the invoice with the status updated to “confirmed” may be transmitted to the core system 3 together with the output information 3200 in FIG. 32 by the information transmission unit 406 of the transaction management system 100, for example. Thereby, a system included in the core system 3, such as an accounting system or a payment system, executes a payment process based on the information of the invoice with the status updated to “confirmed.”

With the above-described processes, if the billing amount in the invoice is changed by the supplier 20, the buyer 10 is able to readily check the reason for the change in the billing amount by displaying the notification information.

According to the embodiment, therefore, the transaction management system 100, which executes the matching between the form issued by the buyer 10 and the form issued by the supplier 20 and determines the payment based on the matching result, reduces the workload on the buyer 10 in the case of a change in the billing price.

In the foregoing embodiment, the order sheet is an example of the first type of form, and the invoice is an example of the second type of form. For example, the transaction management system 100 may use various types of forms used in transactions (e.g., quotation, statement of delivery, and receipt) or may use two or more of the various types of forms in combination.

The apparatuses described in the embodiment form one of a plurality of computing environments for implementing the embodiment disclosed in the present specification. In an embodiment of the present invention, the transaction management system 100 is a server cluster including a plurality of computing devices configured to communicate with each other via a desired type of communication link such as a network or a shared memory, for example, to execute the processes disclosed in the present specification.

Further, the functional units of the transaction management system 100 may be integrated in a single server, or may be distributed to a plurality of apparatuses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An information processing apparatus comprising circuitry configured to
register information of a first type of form based on first input information from a first terminal apparatus,
based on the information of the first type of form, cause a second terminal apparatus different from the first terminal apparatus to display an input screen for receiving input of information of a second type of form corresponding to the first type of form,
register the information of the second type of form based on second input information input on the input screen, and
when the second input information includes an unmatched information item that fails to match a corresponding information item in the information of the first type of form corresponding to the second type of form, cause the second terminal apparatus to display a registration screen for inputting notification information related to the unmatched information item.

2. The information processing apparatus of claim 1, wherein the circuitry registers the notification information input on the registration screen in association with the second type of form.

3. The information processing apparatus of claim 1, wherein the circuitry causes the first terminal apparatus to display the information of the second type of form and the notification information corresponding to the second type of form.

4. The information processing apparatus of claim 3, wherein the circuitry causes the first terminal apparatus to display a check screen including the information of the first type of form and the information of the second type of form, and
wherein when the notification information corresponding to the second type of form exists, the circuitry causes the first terminal apparatus to display a display element on the check screen to display the notification information.

5. The information processing apparatus of claim 1, wherein the notification information includes information indicating a reason for unmatching between the information of the first type of form and the second input information.

6. The information processing apparatus of claim 1, wherein the first type of form is an order sheet or a purchase order, and the second type of form is an invoice.

7. The information processing apparatus of claim 6, wherein each of the invoice and the order sheet or the purchase order includes description information, and
wherein when the description information of the invoice input on the input screen fails to match the description information of the order sheet or the purchase order corresponding to the invoice, the circuitry causes the second terminal apparatus to display the registration screen for inputting the notification information, the notification information indicating a reason for unmatching between the description information of the invoice and the description information of the order sheet or the purchase order.

8. An information processing system comprising:
an information processing apparatus communicable with a first terminal apparatus and a second terminal apparatus different from the first terminal apparatus; and
the second terminal apparatus,
the information processing apparatus including first circuitry configured to
register information of a first type of form based on first input information from the first terminal apparatus,
based on the information of the first type of form, transmit, to the second terminal apparatus, information of an input screen for receiving input of information of a second type of form corresponding to the first type of form, and
register the information of the second type of form based on second input information input on the input screen, and
the second terminal apparatus including
a display configured to display the input screen based on the information of the input screen, and
second circuitry configured to, when the second input information includes an unmatched information item that fails to match a corresponding information item in the information of the first type of form corresponding to the second type of form, control the display to display a registration screen for inputting notification information related to the unmatched information item.

9. An information processing method comprising:
registering information of a first type of form based on first input information from a first terminal apparatus;
based on the information of the first type of form, causing a second terminal apparatus different from the first terminal apparatus to display an input screen for receiving input of information of a second type of form corresponding to the first type of form; and
registering the information of the second type of form based on second input information input on the input screen,
wherein when the second input information includes an unmatched information item that fails to match a corresponding information item in the information of the first type of form corresponding to the second type of form, the method further comprises causing the second terminal apparatus to display a registration screen for inputting notification information related to the unmatched information item.

10. The information processing method of claim 9, further comprising:
registering the notification information input on the registration screen in association with the second type of form.

11. The information processing method of claim 9, further comprising:
causing the first terminal apparatus to display the information of the second type of form and the notification information corresponding to the second type of form.

12. The information processing method of claim 11, further comprising:
causing the first terminal apparatus to display a check screen including the information of the first type of form and the information of the second type of form,
wherein when the notification information corresponding to the second type of form exists, the method further comprises causing the first terminal apparatus to display a display element on the check screen to display the notification information.

13. The information processing method of claim 9, wherein the notification information includes information indicating a reason for unmatching between the information of the first type of form and the second input information.

14. The information processing method of claim 9, wherein the first type of form is an order sheet or a purchase order, and the second type of form is an invoice.

15. The information processing method of claim 14, wherein each of the invoice and the order sheet or the purchase order includes description information, and
wherein when the description information of the invoice input on the input screen fails to match the description information of the order sheet or the purchase order corresponding to the invoice, the method further comprises causing the second terminal apparatus to display the registration screen for inputting the notification information, the notification information indicating a reason for unmatching between the description information of the invoice and the description information of the order sheet or the purchase order.
